(19) United States
(12) Patent Application Publication
(10) Pub. No.: US 2025/0215663 A1
(43) Pub. Date: Jul. 3, 2025

(54) EXCAVATOR, DISPLAY APPARATUS, AND REMOTE OPERATION ASSISTANCE APPARATUS

(71) Applicant: SUMITOMO CONSTRUCTION MACHINERY CO., LTD., Tokyo (JP)

(72) Inventor: Yuiki MATSUHASHI, Chiba (JP)

(21) Appl. No.: 18/978,425

(22) Filed: Dec. 12, 2024

(30) Foreign Application Priority Data
Dec. 28, 2023 (JP) 2023-223678

(51) Int. Cl. E02F 9/20; E02F 3/32; E02F 3/43; E02F 9/22; E02F 9/26; G06F 3/14

(52) U.S. Cl. CPC E02F 9/2004; E02F 3/32; E02F 3/435; E02F 9/205; E02F 9/26; E02F 9/2203; E02F 9/2285; E02F 9/2292; E02F 9/2296; G06F 3/14

(57) ABSTRACT

An excavator includes: a lower travel body; an upper slewing body mounted on the lower travel body in a slewable manner; an attachment attached to the upper slewing body; a control device configured to perform control related to activity of the excavator; a first input apparatus configured to receive an input from a user; and a display apparatus configured to display a screen operable in response to an input from the first input apparatus. The control device has a plurality of control modes for the control related to the activity of the excavator, and the display apparatus is configured to display one predetermined screen on which the user can discretionarily select one control mode from the plurality of control modes by performing an operation through use of the first input apparatus.

### CROSS-REFERENCE TO RELATED APPLICATIONS

Priority is claimed to Japanese Patent Application No. 2023-223678, filed Dec. 28, 2023, the entire content of which is incorporated herein by reference.

### BACKGROUND

### 1. Technical Field The present disclosure relates to an excavator and the like.

### 2. Description of Related Art

Various functions are mounted on an excavator, and control related to the activity of the excavator is performed in accordance with the various functions in some cases.

An excavator is equipped with functions, such as a machine guidance and machine control function, a function for crane work, and a function of detecting a load of earth and sand for work of loading earth and sand onto a dump truck.

Incidentally, in order to use various functions mounted on the excavator, a user needs to operate the excavator while switching between a plurality of control modes including control modes corresponding to the respective functions.

### SUMMARY

According to one aspect of the present disclosure, an excavator includes: a lower travel body; an upper slewing body mounted on the lower travel body in a slewable manner; an attachment attached to the upper slewing body; a control device configured to perform control related to activity of the excavator; a first input apparatus configured to receive an input from a user; and a display apparatus configured to display a screen operable in response to an input from the first input apparatus. The control device has a plurality of control modes for the control related to the activity of the excavator, and the display apparatus is configured to display one predetermined screen on which the user can discretionarily select one control mode from the plurality of control modes by performing an operation through use of the first input apparatus.

### BRIEF DESCRIPTION OF THE DRAWINGS

FIG. 1 is a side view illustrating an example of an excavator;

FIG. 2 is a top view illustrating an example of the excavator;

FIG. 3 is a diagram illustrating an example of a configuration the excavator;

FIG. 4 is a top view illustrating an example of an interior of a cab;

FIG. 5 is a diagram illustrating a first example of a screen of a display apparatus;

FIG. 6 is a diagram illustrating a second example of the screen of the display apparatus;

FIG. 7 is a diagram illustrating a third example of the screen of the display apparatus;

FIG. 8 is a diagram illustrating a fourth example of the screen of the display apparatus;

FIG. 9 is a diagram illustrating an example of a remote operation system; and

FIG. 10 is a diagram illustrating an example of a configuration of a remote operation assistance apparatus.

### DETAILED DESCRIPTION

One embodiment of the present disclosure provides an excavator including: a lower travel body; an upper slewing body mounted on the lower travel body in a slewable manner; an attachment attached to the upper slewing body; a control device configured to perform control related to activity of the excavator; a first input apparatus configured to receive an input from a user; and a display apparatus configured to display a screen operable in response to an input from the first input apparatus. The control device has a plurality of control modes for the control related to the activity of the excavator. The display apparatus displays one predetermined screen on which the user can discretionarily select one control mode from the plurality of control modes by performing an operation through use of the first input apparatus.

Another embodiment of the present disclosure provides a display apparatus for assisting an operation of an excavator. The excavator includes a lower travel body, an upper slewing body mounted on the lower travel body in a slewable manner, an attachment attached to the upper slewing body, and a control device configured to perform control related to activity of the excavator and having a plurality of control modes for the control related to the activity of the excavator. The display apparatus displays one predetermined screen on which a user can discretionarily select one control mode from the plurality of control modes by performing an operation through use of an input apparatus.

Still another embodiment of the present disclosure provides a remote operation assistance apparatus including the above-described display apparatus, the input apparatus, and an operation device for a user to remotely operate the above-described excavator, and a communication device configured to transmit operation content of the operation device and operation content of the one predetermined screen to the excavator.

According to the above-described embodiments, a user can easily switch between a plurality of control modes of an excavator.

Hereinafter, embodiments will be described with reference to the drawings.

### (Outline of Excavator)

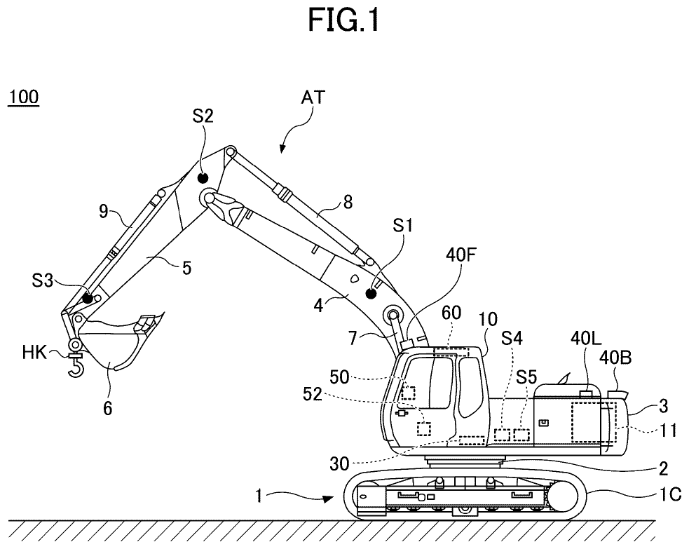

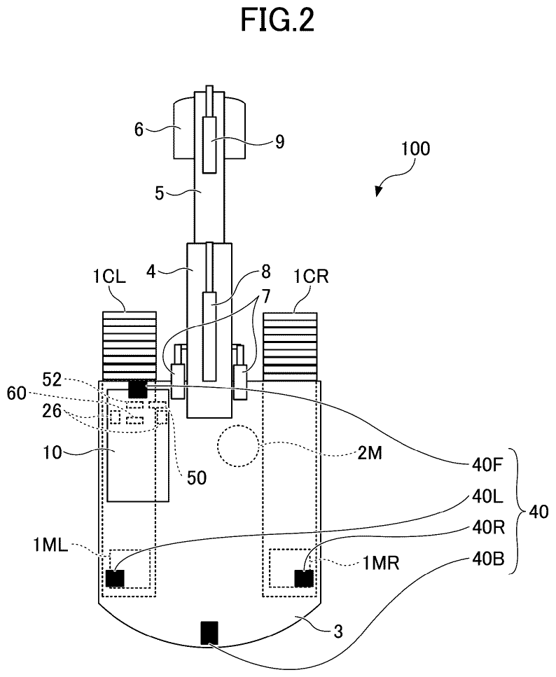

The outline of an excavator 100 according to the present embodiment will be described with reference to FIGS. 1 and 2.

FIG. 1 is a side view illustrating an example of an excavator 100. FIG. 2 is a top view illustrating an example of the excavator 100. Hereinafter, a direction in the excavator 100 or a direction viewed from the excavator 100 may be described by defining a direction in which the attachment AT extends in a top view of the excavator 100 as “front”.

As illustrated in FIG. 1, the excavator 100 includes a lower travel body 1, an upper slewing body 3, a boom 4, an arm 5, an attachment AT including a bucket 6, and a cab 10.

The lower travel body 1 causes the excavator 100 to travel by using a pair of left and right crawlers 1C. The crawlers 1C include a left crawler 1CL and a right crawler 1CR. The left crawler 1CL and the right crawler 1CR are hydraulically driven by travel hydraulic motors 1ML and 1MR, respectively. Thus, the lower travel body 1 can travel by itself.

The upper slewing body 3 is slewably mounted on the lower travel body 1 via the slew mechanism 2. For example, the upper slewing body 3 can slew with respect to the lower travel body 1 due to the slew mechanism 2 being hydraulically driven by a slew hydraulic motor 2M.

The boom 4 is attached to the center of the front portion of the upper slewing body 3 so as to be able to be elevated and lowered about a rotation axis along the left-right direction. The arm 5 is attached to the distal end of the boom 4 so as to be rotatable about a rotation axis along the left-right direction. The bucket 6 is attached to the distal end of the arm 5 so as to be rotatable about a rotation axis along the left-right direction.

The bucket 6 is an example of an end attachment, and is used for, for example, excavation work, slope work, and leveling work.

The bucket 6 is attached to the distal end of the arm 5 in a replaceable manner as appropriate according to work of the excavator 100. In other words, instead of the bucket 6, a bucket of a type different from the bucket 6, for example, a large bucket relatively larger than the bucket 6, a slope bucket, a dredging bucket, or the like may be attached to the distal end of the arm 5. An end attachment of a type other than a bucket, for example, a stirrer, a breaker, a crusher, or the like may be attached to the distal end of the arm 5. An auxiliary attachment, for example, a quick coupler or a tilt rotator, may be provided between the arm 5 and the end attachment.

A hook HK, for example, is attached to the bucket 6. Thus, the excavator 100 can move a suspended load by suspending the suspended load on the hook HK and operating at least one of the lower travel body 1, the upper slewing body 3, and the attachment AT.

The hook HK has a proximal end rotatably connected to a bucket pin connecting the arm 5 and the bucket 6. Thus, the hook HK can be housed in a space formed between two bucket links when work other than hanging work (also referred to as “crane work”), such as excavation work, is performed.

The boom 4, the arm 5, and the bucket 6 are hydraulically driven by a boom cylinder 7, an arm cylinder 8, and a bucket cylinder 9, respectively.

The cab 10 is a control room (also referred to as an “operator's cab”) in which an operator boards and operates the excavator 100. The cab 10 is mounted on, for example, the left side of the front portion of the upper slewing body 3.

For example, the excavator 100 operates driven elements, such as the lower travel body 1 (that is, the pair of left and right crawlers 1CL and 1CR), the upper slewing body 3, the boom 4, the arm 5, and the bucket 6 in response to an operation of an operator who boards the cab 10.

The excavator 100 may automatically operate the actuators regardless of content of the operator's operation. Thus, the excavator 100 can realize a function of automatically operating at least some of the driven elements, such as the lower travel body 1, the upper slewing body 3, and the attachment AT, that is, a so-called “automatic operation function” or a “machine control (MC) function”.

The automatic operation function includes, for example, a semi-automatic operation function (operation support type MC function). The semi-automatic operation function is a function of automatically operating a driven element (actuator) other than a driven element (actuator) to be operated in response to an operator's operation. The automatic operation function may include a fully automatic operation function (fully automatic MC function). The fully automatic operation function is a function of automatically operating at least some of a plurality of driven elements (actuators) on the premise that there is no operator's operation. In the excavator 100, in the case where the fully automatic operation function is enabled, the inside of the cab 10 may be in an unmanned state. The semi-automatic operation function, the fully automatic operation function, and the like include, for example, a rule-based automatic operation function. The rule-based automatic operation function is an automatic operation function in which operation content of a driven element (actuator) of an automatic operation target is automatically determined according to a rule defined in advance. The semi-automatic operation function, the fully automatic operation function, and the like may include an autonomous operation function. The autonomous operation function is an automatic operation function in which the excavator 100 autonomously makes various determinations and operation content of a driven element (actuator) to be automatically operated is determined based on the determination result.

### (Configuration of Excavator)

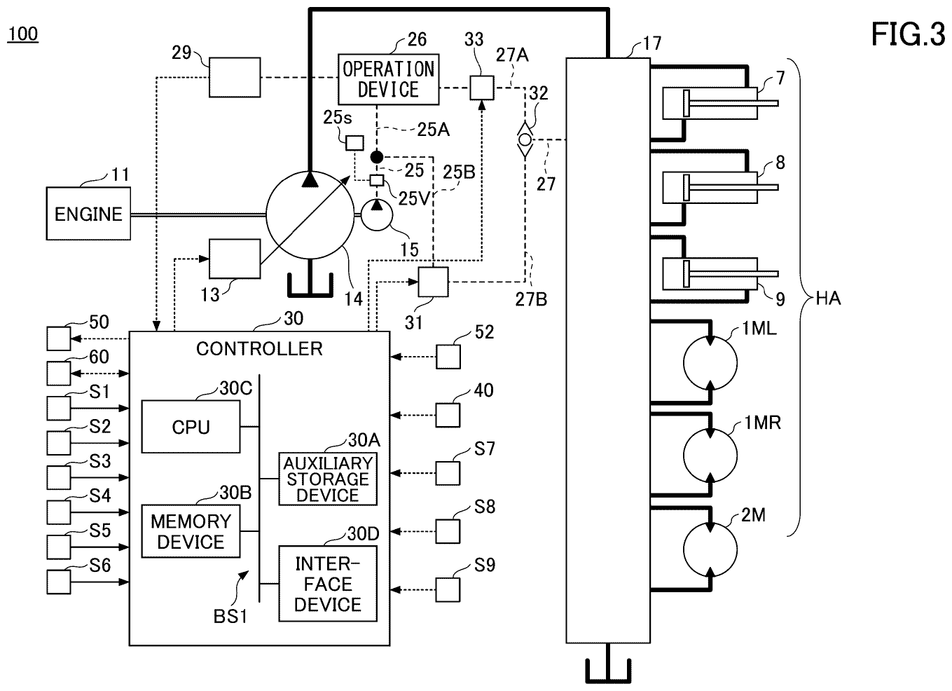

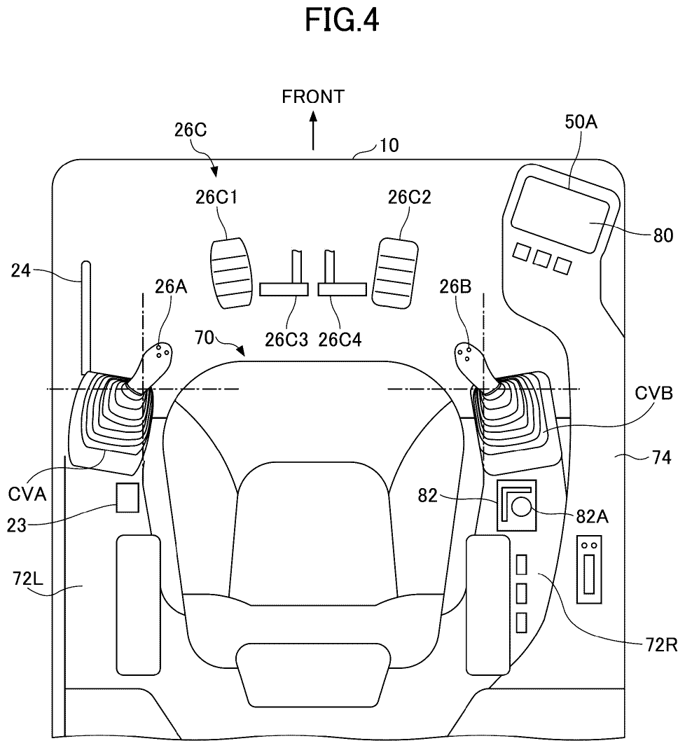

Next, a configuration of the excavator 100 will be described with reference to FIGS. 3 and 4 in addition to FIGS. 1 and 2.

FIG. 3 is a diagram illustrating an example of a configuration of the excavator 100. FIG. 4 is a top view illustrating an example of an interior of the cab 10.

In FIG. 3, a path through which mechanical power is transmitted is indicated by a double line; a path through which a high-pressure hydraulic oil for driving the hydraulic actuators flows is indicated by a thick solid line; a path through which a pilot pressure is transmitted is indicated by a broken line; a path of fuel is indicated by an alternate long and short dash line; and a path through which an electric signal is transmitted is indicated by a dotted line.

The excavator 100 includes constituent elements of a hydraulic drive system, an operation system, a user interface system, a control system, etc.

### <Hydraulic Drive System>

The hydraulic drive system of the excavator 100 is a group of components related to hydraulic driving of the driven elements of the excavator 100.

As illustrated in FIG. 3, the hydraulic drive system of the excavator 100 includes hydraulic actuators HA that hydraulically drive respective driven elements, such as the lower travel body 1 (that is, the left and right crawlers 1C), the upper slewing body 3, the boom 4, the arm 5, and the bucket 6, as described above. The hydraulic drive system of the excavator 100 according to the present embodiment includes an engine 11, a regulator 13, a main pump 14, and a control valve 17.

The hydraulic actuators HA include travel hydraulic motors 1ML and 1MR, a slew hydraulic motor 2M, a boom cylinder 7, an arm cylinder 8, a bucket cylinder 9, and the like.

In the excavator 100, a part or all of the hydraulic actuators HA may be replaced with electric actuators. In other words, the excavator 100 may be a hybrid excavator or an electric excavator.

The engine 11 is a prime mover of the excavator 100 and is a main power source in the hydraulic drive system. The engine 11 is, for example, a diesel engine using diesel fuel. The engine 11 is mounted on, for example, a rear portion of the upper slewing body 3. For example, the engine 11 rotates at a constant target rotation speed that is set in advance under direct or indirect control by a controller 30 (which is described later), and drives the main pump 14 and a pilot pump 15.

Instead of or in addition to the engine 11, another prime mover (for example, an electric motor) or the like may be mounted on the excavator 100.

The regulator 13 adjusts the discharge amount of the main pump 14 under the control by the controller 30. For example, the regulator 13 adjusts an angle of a swashplate of the main pump 14 (hereinafter a “tilting angle”) in response to a control command from the controller 30.

The main pump 14 supplies a hydraulic oil to the control valve 17 via a high-pressure hydraulic line. The main pump 14 is mounted, for example, on the rear portion of the upper slewing body 3, similarly to the engine 11. The main pump 14 is driven by the engine 11 as described above. The main pump 14 is, for example, a variable displacement hydraulic pump, and as described above, a stroke length of the piston is adjusted by adjusting the tilting angle of the swashplate with the regulator 13 under the control by the controller 30, and a discharge flow rate and a discharge pressure are thereby controlled.

The control valve 17 drives the hydraulic actuators HA in response to an operator's operation of an operation device 26 or an operator's operation command corresponding to the automatic operation function. The control valve 17 is mounted, for example, in a central portion of the upper slewing body 3. As described above, the control valve 17 is connected to the main pump 14 via the high-pressure hydraulic line, and selectively supplies the hydraulic oil supplied from the main pump 14 to each hydraulic actuator in response to an operator's operation of the operation device 26 or an operator's operation command corresponding to the automatic operation function. Specifically, the control valve 17 includes a plurality of direction switching valves that control a flow rate and a flow direction of a hydraulic oil supplied from the main pump 14 to each of the hydraulic actuators HA.

### <Operation System>

The operation system of the excavator 100 is a group of constituent elements related to the operation of the driven elements.

As illustrated in FIGS. 3 and 4, the operation system of the excavator 100 includes the pilot pump 15, the gate lock valve 25V, the operation device 26, the hydraulic control valves 31, the shuttle valves 32, and the hydraulic control valve 33.

The pilot pump 15 supplies a pilot pressure to various hydraulic devices (for example, the operation device 26) via a pilot line 25. The pilot pump 15 is mounted, for example, on the rear portion of the upper slewing body 3, similarly to the engine 11. The pilot pump 15 is, for example, a fixed displacement hydraulic pump and driven by the engine 11, as described above.

The pilot pump 15 may be omitted. In this case, the hydraulic fluid discharged from the main pump 14 and reduced in pressure to a predetermined pilot pressure via a pressure reducing valve or the like may be supplied to various hydraulic devices, such as the operating device 26.

The gate lock valve 25V is provided in the pilot line 25 at a position upstream of all the various hydraulic devices that receive a supply of a hydraulic oil from the pilot pump 15. The gate lock valve 25V switches between communication and shutoff (non-communication) of the pilot line 25 by turning on and off a limit switch 25s that operates in conjunction with an operation state of a gate lever 23 provided inside the cab 10.

The gate lever 23 is a mechanical input apparatus for switching between a state in which the excavator 100 can be activated and the excavator 100 can be operated by the operation device 26 and a state in which the excavator 100 cannot be activated or operated. For example, the gate lever 23 is provided on the upper surface of a console 72L on the left side of the operator's seat 70. For example, the controller 30 controls permission or prohibition of activation of the excavator 100 including the start of the engine 11 according to an operation state of the gate lever 23. As described above, the gate lever 23 can switch between communication and non-communication of the pilot line 25 according to an operation state of the gate lever 23, and as a result, the gate lever 23 can switch between a state in which the hydraulic actuators HA of the excavator 100 can be operated and a state in which the hydraulic actuators HA cannot be operated.

A gate bar 24 that operates in conjunction with an operation state of the gate lever 23 is disposed on the front surface of the console 72L on the left side of the operator's seat 70. In the case where the gate lever 23 is in a state in which the excavator 100 can be operated, the gate bar 24 is in a state in which the gate bar 24 is raised forward so as to block the left-right movement between the operator's seat 70 and the entrance of the cab 10 (see FIG. 4). On the other hand, in the case where the gate lever is in a state in which the excavator 100 cannot be operated (a lock position), the gate bar 24 is accommodated in the console 72L in a state of being laid down downward so as to allow the gate bar 24 to move in the left-right direction between the operator's seat 70 and the entrance of the cab 10. Thus, an operator cannot operate the excavator 100 unless the gate bar 24 is in a state of protruding forward in accordance with the operation of the gate lever 23, and the safety of the excavator 100 can be improved.

The operation device 26 is provided within reach of an operator in the operator's seat 70 of the cab 10, and is used by the operator to operate the respective driven elements, that is, the left and right crawlers of the lower travel body 1, the upper slewing body 3, the boom 4, the arm 5, the bucket 6, and the like. Specifically, the operating device 26 is used by the operator to operate the hydraulic actuator HA that drives each driven element.

For example, as illustrated in FIG. 3, the operating device 26 is a hydraulic pilot type. Specifically, the operation device 26 outputs a pilot pressure corresponding to operation content to a pilot line 27A on the secondary side by using a hydraulic oil supplied from the pilot pump 15 through the pilot line 25 and a pilot line 25A branching therefrom. The pilot line 27A is connected to one of the inlet ports of the shuttle valve 32, and is connected to the control valve 17 via the pilot line 27 connected to the outlet port of the shuttle valve 32. A pilot pressure corresponding to operation content related to each hydraulic actuator HA in the operation device 26 is thereby input to the control valve 17 via the shuttle valve 32. For this reason, the control valve 17 can drive each hydraulic actuator HA in accordance with content of an operator's or someone else's operation of the operation device 26.

The operation device 26 may be an electric type. In this case, the pilot line 27A, the shuttle valve 32, and the hydraulic control valve 33 are omitted. Specifically, the operation device 26 outputs an electric signal (hereinafter, referred to as an “operation signal”) corresponding to operation content, and the operation signal is input to the controller 30. The controller 30 outputs a control command corresponding to content of the operation signal, that is, a control signal corresponding to operation content related to the operation device 26, to the hydraulic control valve 31. Thus, a pilot pressure corresponding to operation content related to the operation device 26 is input from the hydraulic control valve 31 to the control valve 17, and the control valve 17 can drive each hydraulic actuator HA according to the operation content related to the operation device 26.

The control valve (direction switching valve) built in the control valve 17 for driving each hydraulic actuator HA may be an electromagnetic solenoid type. In this case, the operation signal that is output from the operation device 26 may be directly input to the control valve 17 (that is, to the electromagnetic solenoid type control valve).

As described above, some or all of the hydraulic actuators HA may be replaced with electric actuators. In this case, the controller 30 may output a control command corresponding to operation content related to the operation device 26 or content of a remote operation defined by a remote operation signal to the electric actuator or a driver or the like that drives the electric actuator.

As illustrated in FIG. 4, the operation device 26 includes a left lever device 26A, a right lever device 26B, and a pedal device 26C.

The left lever device 26A is disposed, for example, in the front portion of the upper surface of the console 72L on the left side of the operator's seat 70 in the cab 10, and the base portion of the left lever device is covered with a lever cover CVA. The left lever device 26A is used by an operator to operate any two of the slew hydraulic motor 2M, the boom cylinder 7, the arm cylinder 8, and the bucket cylinder 9. Thus, an operator seated on the operator's seat 70 can operate the left lever device 26A with the left hand to operate two hydraulic actuators HA of the slew hydraulic motor 2M, the boom cylinder 7, the arm cylinder 8, and the bucket cylinder 9. For example, an operation target of the left lever device 26A is the slew hydraulic motor 2M and the arm cylinder 8, the slew hydraulic motor 2M is operated by an operation of the left lever device 26A in a lateral direction, and the arm cylinder 8 is operated by the operation of the left lever device 26A in a longitudinal direction. The longitudinal direction and the lateral direction of the left lever device 26A correspond to the front-rear direction and the left-right direction of the excavator 100, respectively, and the same applies to the longitudinal direction and the lateral direction of the right lever device 26B, which is described later.

The right lever device 26B is disposed, for example, in the front portion of the upper surface of the console 72R on the left side of the operator's seat 70 in the cab 10, and the base portion of the right lever device 26B is covered with a lever cover CVB. The right lever device 26B is used for the operator to operate the remaining two of the slew hydraulic motor 2M, the boom cylinder 7, the arm cylinder 8, and the bucket cylinder 9 that are not operation targets of the left lever device 26A. Thus, an operator seated on the operator's seat 70 can operate the right lever device 26B with the right hand to operate two hydraulic actuators HA of the slew hydraulic motor 2M, the boom cylinder 7, the arm cylinder 8, and the bucket cylinder 9. For example, the operation targets of the right lever device 26B are the boom cylinder 7 and the bucket cylinder 9, the boom cylinder 7 is operated by the operation of the right lever device 26B in the longitudinal direction, and the bucket cylinder 9 is operated by the operation of the right lever device 26B in the lateral direction.

The pedal device 26C is disposed on a floor surface in front of the operator's seat in the interior of the cab 10. The pedal device 26C is used for an operator to operate the travel hydraulic motor 1ML and the travel hydraulic motor 1MR. The pedal device 26C includes a left pedal 26C1, a right pedal 26C2, a left lever 26C3, and a right lever 26C4.

The left pedal 26C1 is used by an operator to operate the travel hydraulic motor 1ML that drives the left crawler 1CL. An operator seated on the operator's seat 70 can operate the travel hydraulic motor 1ML by operating the left pedal 26C1 with the left foot.

The right pedal 26C2 is used by an operator to operate the travel hydraulic motor 1MR that drives the right crawler 1CR. An operator seated on the operator's seat 70 can operate the travel hydraulic motor 1MR by operating the right pedal 26C2 with the right foot.

The left lever 26C3 is used by an operator to operate the travel hydraulic motor 1ML that drives the left crawler 1CL. An operator seated on the operator's seat 70 can operate the travel hydraulic motor 1ML by operating the left lever 26C3 with the left hand.

The right lever 26C4 is used by an operator to operate the travel hydraulic motor 1MR that drives the right crawler 1CR. An operator seated on the operator's seat 70 can operate the travel hydraulic motor 1MR by operating the right lever 26C4 with the right hand.

The hydraulic control valve 31 is provided for each hydraulic actuator HA to be operated by the operating device 26 and for each driving direction of the hydraulic actuator HA (for example, the extending direction and the retracting direction of the boom cylinder 7). For example, a pair of hydraulic control valves 31 is provided for each double-acting hydraulic actuator HA for driving the lower travel body 1, the upper slewing body 3, the boom 4, the arm 5, the bucket 6, and the like. The hydraulic control valve 31 may be provided, for example, in a pilot line 25B between the pilot pump 15 and the control valve 17, and may be configured to be able to change the flow passage area of the pilot line 25B (that is, the cross-sectional area through which a hydraulic oil can flow). Thus, the hydraulic control valve 31 can output a predetermined pilot pressure to the pilot line 25B on the secondary side by using a hydraulic oil of the pilot pump 15 supplied through a pilot line 27B. For this reason, the hydraulic control valve 31 can indirectly cause a predetermined pilot pressure corresponding to a control signal from the controller 30 to act on the control valve 17 through the shuttle valve 32 between the pilot line 27B and the pilot line 27. Therefore, for example, the controller 30 can cause a pilot pressure in accordance with an operation command corresponding to the automatic operation function from the hydraulic control valve 31 to act on the control valve 17, and can realize activity of the excavator 100 by the automatic operation function.

In the case where the operation device 26 is an electric type, the controller 30 can cause a pilot pressure in accordance with operation content (operation signal) of the operation device 26 to directly act on the control valve 17 from the hydraulic control valve 31, and realize activity of the excavator 100 based on an operator's operation.

The shuttle valve 32 has two inlet ports and one outlet port, and outputs a hydraulic oil having the higher pilot pressure, among the pilot pressures that have been input to the two inlet ports, to the outlet port. The shuttle valve 32 is provided for each hydraulic actuator HA to be operated by the operating device 26 and for each driving direction of the hydraulic actuator HA, similarly to the hydraulic control valve 31. For example, a pair of shuttle valves 32 is provided for each double-acting hydraulic actuator HA for driving the lower travel body 1, the upper slewing body 3, the boom 4, the arm 5, the bucket 6, and the like. One of two inlet ports of the shuttle valves 32 is connected to the pilot line 27A on the secondary side of the operating device 26 (to be specific, the above-described lever device or pedal device included in the operating device 26), and the other is connected to the pilot line 27B on the secondary side of the hydraulic control valve 31. The outlet port of the shuttle valve 32 is connected to a pilot port of a corresponding direction switching valve of the control valve 17 through the pilot line 27. The corresponding control valve is a direction switching valve that drives the hydraulic actuator HA that is a target of an operation by the left lever device 26A, the right lever device 26B, or the pedal device 26C connected to one of the inlet ports of the shuttle valve 32. Therefore, each of these shuttle valves 32 can cause the higher one among the pilot pressure of the pilot line 27A on the secondary side of the operating device 26 and the pilot pressure of the pilot line 27B on the secondary side of the hydraulic control valve 31 to act on the pilot port of the corresponding control valve. In other words, the controller 30 can control the corresponding direction switching valve regardless of an operation of the operation device 26 by an operator by outputting a pilot pressure higher than a pilot pressure on the secondary side of the operation device 26 from the hydraulic control valve 31. Therefore, the controller 30 can control the operation of the driven elements (i.e., the lower travel body 1, the upper slewing body 3, the boom 4, the arm 5, and the bucket 6) regardless of an operation state of the operation device 26 being operated by an operator, and can realize the automatic operation function.

The hydraulic control valve 33 is provided in the pilot line 27A that connects the operating device 26 and the shuttle valve 32. The hydraulic control valve 33 is configured to be able to change, for example, the flow passage area thereof. The hydraulic control valve 33 operates in response to a control signal that is input from the controller 30. The controller 30 can thereby forcibly reduce a pilot pressure that is output from the operating device 26 in the case where the operating device 26 is being operated by an operator. For this reason, even in the case where the operation device 26 is being operated, the controller 30 can forcibly decelerate or stop the operation of the hydraulic actuator HA corresponding to the operation of the operation device 26. Furthermore, for example, even in the case where the operating device 26 is being operated, the controller 30 can reduce a pilot pressure that is output from the operating device 26 to be lower than a pilot pressure that is output from the hydraulic control valve 31. For this reason, the controller 30 can reliably cause a desired pilot pressure to act on the pilot port of the direction switching valve in the control valve 17, for example, regardless of operation content related to the operation device 26 by controlling the hydraulic control valve 31 and the hydraulic control valve 33. Therefore, the controller 30 can more appropriately realize the automatic operation function of the excavator 100 by controlling the hydraulic control valve 33 in addition to the hydraulic control valve 31, for example.

### <User Interface System>

The user interface system of the excavator 100 is a group of constituent elements related to exchange of information between a user and the excavator 100.

As illustrated in FIG. 3, the user interface system of the excavator 100 includes the operation device 26, an output apparatus 50, and an input apparatus 52.

The output apparatus 50 outputs various kinds of information to a user of the excavator 100 (for example, an operator of the cab 10 or an operator of an external remote operation), a person in the vicinity of the excavator 100 (for example, a worker or a driver of a work vehicle), or the like.

For example, as illustrated in FIG. 4, the output apparatus 50 includes a display apparatus 50A that outputs various kinds of information in a visual manner. The display apparatus 50A is, for example, a liquid-crystal display, an organic electroluminescence (EL) display, or the like. For example, as illustrated in FIG. 4, the display apparatus 50A is provided in a right front portion inside the cab 10, and outputs various kinds of information to an operator or the like inside the cab 10 by a visual method.

The output apparatus 50 may include a sound output apparatus that outputs various kinds of information by an auditory method. The sound output apparatus includes, for example, a buzzer, a speaker, and the like. The sound output apparatus may be provided, for example, in at least one of the inside and the outside of the cab 10, and output various kinds of information to an operator inside the cab 10 or a person (worker or the like) in the vicinity of the excavator 100 by an auditory method.

The output apparatus 50 may include a lighting device that outputs various kinds of information in a visual manner. The lighting device is, for example, a warning lamp (also referred to as an “indicator lamp”) inside the cab 10, an external display lamp attached to the upper slewing body 3, or the like. For example, the lighting device is provided inside the cab 10 and outputs various kinds of information to an operator or the like inside the cab 10 in a visual manner. The lighting device may be provided on the upper surface, the side surface, or the like of the house portion of the upper slewing body 3 and output various kinds of information to a worker or the like in the vicinity of the excavator 100 in a visual manner.

The output apparatus 50 may include a device that outputs various kinds of information by a tactile method, such as vibration of the operator's seat 70.

The input apparatus 52 receives various inputs from a user of the excavator 100, and signals corresponding to the received inputs are taken into the controller 30. For example, the input apparatus 52 is provided inside the cab 10 and receives an input from an operator or the like inside the cab 10. The input apparatus 52 may be provided on, for example, a side surface of the house portion of the upper slewing body 3, and may receive an input from a worker or the like in the vicinity of the excavator 100.

For example, the input apparatus 52 includes a mechanical input apparatus that receives an input by a mechanical operation from a user. The mechanical input apparatus includes, for example, a touch panel, a touch pad, a button switch, a lever, a toggle, a knob switch, and the like. For example, the input apparatus 52 (mechanical input apparatus) provided inside the cab 10 includes a touch panel 80 and a switch panel 82. The input apparatus 52 (mechanical input apparatus) provided inside the cab 10 may also include various levers, switches, dials, switches associated with the display apparatus 50A, and the like installed on the consoles 72L and 72R and a console 74.

The touch panel 80 is mounted on the display apparatus 50A and is configured to be able to operate a screen displayed on the display apparatus 50A.

The switch panel 82 is provided on the upper surface of the console 72R on the right side of the operator's seat 70. The switch panel 82 includes a dial 82A.

The dial 82A has a cylindrical shape and is configured to be rotatable around a central shaft. The dial 82A has, for example, a rotary encoder capable of detecting a rotation angle of the dial 82A built-in, and a signal corresponding to a rotation state of the rotary encoder is input to the controller 30. An operator can thereby adjust an output of the prime mover by, for example, rotating the dial 82A. The dial 82A is configured to be pushed downward toward the console 72R and has a push switch function. An operator can thereby switch the control mode of the controller 30, which will be described later, in accordance with, for example, a press operation of the dial 82A.

The input apparatus 52 may include a voice input apparatus that receives a voice input from a user. The voice input apparatus includes, for example, a microphone.

The input apparatus 52 may include a gesture input apparatus that receives a gesture input of a user. The gesture input apparatus includes, for example, an imaging device that images a state of a gesture performed by a user.

The input apparatus 52 may include a biometric input apparatus that receives a biometric input of a user. The biometric input includes, for example, an input of biometric information, such as a fingerprint or an iris of a user.

### <Communication System>

As illustrated in FIG. 3, the communication system of the excavator 100 according to the present embodiment includes a communication device 60.

The communication device 60 is connected to an external communication line and communicates with a device provided separately from the excavator 100. The device provided separately from the excavator 100 may include a portable terminal device (portable terminal) brought into the cab 10 by a user of the excavator 100, in addition to the device outside the excavator 100. The communication device 60 may include, for example, a mobile communication module conforming to a standard such as 4G (4th Generation) or 5G (5th Generation). The communication device 60 may include, for example, a satellite communication module. The communication device 60 may include, for example, a WiFi communication module or a Bluetooth (registered trademark) communication module. In addition, in the case where there are a plurality of connectable communication lines NW, the communication device 60 may include a plurality of communication devices according to the types of the communication lines NW.

The communication device 60 may be omitted.

### <Control System>

The control system of the excavator 100 is a group of constituent elements related to various controls of the excavator 100.

As illustrated in FIG. 3, the control system of the excavator 100 includes the controller 30. The control system of the excavator 100 includes an operation pressure sensor 29, an imaging device 40, and sensors S1 to S9.

The controller 30 performs various controls related to the excavator 100.

The functions of the controller 30 may be implemented by discretionarily selected hardware, or a combination of discretionarily selected hardware and software, or the like. For example, as illustrated in FIG. 3, the controller 30 includes an auxiliary storage device 30A, a memory device 30B, a central processing unit (CPU) 30C, and an interface device 30D, which are connected to each other via a bus BS1.

The auxiliary storage device 30A is a non-volatile storage unit, and stores installed programs, as well as necessary files, data, etc. The auxiliary storage device 30A is, for example, an electrically erasable programmable read-only memory (EEPROM), a flash memory, or the like.

The memory device 30B loads a program in the auxiliary storage device 30A in a CPU 30C-readable format in response to an instruction to start the program. The memory device 30B is, for example, a static random access memory (SRAM).

The CPU 30C executes, for example, the program loaded onto the memory device 30B, and implements various functions of the controller 30 in accordance with instructions of the program.

The interface device 30D functions as, for example, a communication interface for connection to a communication line inside the excavator 100. The interface device 30D may include a plurality of different types of communication interfaces in accordance with the type of communication line to be connected.

The interface device 30D functions as an external interface for reading and writing of information from and to a storage medium. The recording medium is, for example, a dedicated tool that is connected to a connector installed inside the cab 10 by a detachable cable. The recording medium may be a general-purpose recording medium such as an SD memory card or a universal serial bus (USB) memory. Thus, the program for realizing various functions of the controller 30 can be provided by, for example, a portable storage medium and installed in the auxiliary storage device 30A of the controller 30. The program may be downloaded from an external computer outside the excavator 100 through the communication device 60 and installed in the auxiliary storage device 30A.

Some of the functions of the controller 30 may be implemented by another controller (control device). In other words, the functions of the controller 30 may be realized in a distributed manner by a plurality of controllers mounted on the excavator 100.

The operation pressure sensor 29 detects a pilot pressure on the secondary side of the hydraulic pilot-type operation device 26 (i.e., the pilot line 27A), that is, a pilot pressure corresponding to an operation state of each of the hydraulic actuators HA in the operation device 26. A detection signal of a pilot pressure corresponding to an operation state of each hydraulic actuator HA in the operation device 26 is input to the controller 30 by the operation pressure sensor 29. Thus, in the case where the operating device 26 is a hydraulic type, the controller 30 can ascertain an operation state of the operating device 26, that is, an operation state of each hydraulic actuator HA, through the operating device 26.

In the case where the operation device 26 is an electric type, the operation pressure sensor 29 is omitted. This is because the controller 30 can ascertain an operation state of each hydraulic actuator HA through the operation device 26 based on an operation signal taken in from the operation device 26.

The imaging device 40 images surroundings of the excavator 100.

The imaging device 40 is, for example, a monocular camera. The imaging device 40 may be, for example, a three-dimensional camera (3D camera) capable of acquiring not only two-dimensional image information but also three-dimensional information including information about distances to objects appearing in images and depths of the images, such as a stereo camera, a ToF (Time of Flight) camera, or a depth camera.

For example, as illustrated in FIG. 2, the imaging device 40 includes cameras 40F, 40B, 40L, and 40R. The camera 40F captures an image of a region to the front of the upper slewing body 3. The camera 40B captures an image of a region to the rear of the upper slewing body 3. The camera 40L captures an image of a region to the left of the upper slewing body 3. The camera 40R captures an image of a region to the right of the upper slewing body 3. Thus, the imaging device 40 can capture an image of the entire circumference around the excavator 100, that is, an environment of a range over the angular direction of 360 degrees in a top view of the excavator 100. Hereinafter, the cameras 40F, 40B, 40L, and 40R may be collectively referred to as “cameras 40X” or individually referred to as a “camera 40X”.

The data output from the imaging devices 40 (cameras 40X) is taken into the controller 30 via a one-to-one communication line or an in-cab network. Thus, for example, the controller 30 can ascertain an environment of surroundings of the excavator 100 based on the cameras 40X.

Some or all of the cameras 40F, 40B, 40L, and 40R may be omitted. Further, the excavator 100 may be provided with, instead of or in addition to the imaging device 40, a distance measuring sensor (also referred to as a “distance sensor”) capable of acquiring information indicating a distance to an object in the vicinity of the excavator 100. The distance measuring sensor is, for example, a light detecting and ranging (LiDAR) device, a millimeter wave radar, an ultrasonic sensor, or the like.

The sensor S1 is attached to the boom 4 and measures a posture state of the boom 4. The sensor S1 outputs measurement data indicating a posture state of the boom 4. The posture state of the boom 4 is, for example, a posture angle around a rotation axis of a base end corresponding to a connection portion of the boom 4 with the upper slewing body 3 (hereinafter, referred to as a “boom angle”). The sensor S1 includes, for example, a rotary potentiometer, a rotary encoder, an accelerometer, an angular accelerometer, a six-axis sensor, and an inertial measurement unit (IMU). Hereinafter, the same may be applied to the sensors S2 to S4. The sensor S1 may include a cylinder sensor that detects an extension/retraction position of the boom cylinder 7. Hereinafter, the same may be applied to the sensors S2 and S3. Output of the sensor S1 (i.e., measurement data indicating a posture state of the boom 4) is taken into the controller 30. Thus, the controller 30 can ascertain a posture state of the boom 4.

The sensor S2 is attached to the arm 5 and measures a posture state of the arm 5. The sensor S2 outputs measurement data indicating a posture state of the arm 5. The posture state of the arm 5 is, for example, a posture angle around a rotation axis of a base end corresponding to a connection portion of the arm 5 with the boom 4 (hereinafter, referred to as an “arm angle”). Output of the sensor S2 (i.e., measurement data indicating a posture state of the arm 5) is taken into the controller 30. Thus, the controller 30 can ascertain a posture state of the arm 5.

The sensor S3 is attached to the bucket 6 and measures a posture state of the bucket 6. The sensor S3 outputs measurement data indicating a posture state of the bucket 6. The posture state of the bucket 6 is, for example, a posture angle around a rotation axis of a base end corresponding to a connection portion of the bucket 6 with the arm 5 (hereinafter, referred to as an “arm angle”). Output of the sensor S3 (i.e., measurement data indicating a posture state of the bucket 6) is taken into the controller 30. Thus, the controller 30 can ascertain a posture state of the bucket 6.

The sensor S4 measures a posture state of the body (for example, the upper slewing body 3) of the excavator 100. The sensor S4 outputs measurement data indicating a posture state of the body of the excavator 100. The posture state of the body of the excavator 100 is, for example, an inclination state of the body with respect to a predetermined reference plane (for example, a horizontal plane). For example, the sensor S4 is attached to the upper slewing body 3 and measures inclination angles around two axes in the front-rear direction and the left-right direction of the excavator 100 (hereinafter, referred to as a “front-rear inclination angle” and a “left-right inclination angle”). Output of the sensor S4 (i.e., measurement data indicating a posture state of the excavator 100) is taken into the controller 30. Thus, the controller 30 can ascertain the posture state (inclination state) of the body (upper slewing body 3).

The sensor S5 is attached to the upper slewing body 3 and measures the slew state of the upper slewing body 3. The sensor S5 outputs measurement data indicating a slew state of the upper slewing body 3. The sensor S5 measures, for example, a slew angular speed and a slew angle of the upper slewing body 3. The sensor S5 includes, for example, a gyro sensor, a resolver, a rotary encoder, and the like. Output of the sensor S5 (i.e., measurement data indicating a slewing state of the upper slewing body 3) is taken into the controller 30. Thus, the controller 30 can ascertain the slew state, such as the slew angle, of the upper slewing body 3.

The controller 30 can estimate and ascertain the position of the distal end of the attachment AT (that is, the bucket 6) based on the outputs of the sensors S1 to S5.

Note that, in the case where the sensor S4 includes a gyro sensor, a six-axis sensor, an IMU, or the like capable of detecting angular velocities about three axes, a slew state (for example, a slew angular velocity) of the upper slewing body 3 may be detected based on a detection signal of the sensor S4. In this case, the sensor S5 may be omitted.

The sensor S6 measures a position of the excavator 100. The sensor S6 may measure a position in world (global) coordinates or may measure the position in local coordinates at a work site. In the former case, the sensor S6 is, for example, a global navigation satellite system (GNSS) sensor. In the latter case, the sensor S6 is a transmitter/receiver capable of communicating with a device serving as a reference of the position of the work site and outputting a signal corresponding to the position with respect to the reference. The output of the sensor S6 is taken into the controller 30.

The sensor S7 measures a pressure (cylinder pressure) in the oil chamber of the boom cylinder 7. The sensor S7 includes, for example, a sensor that measures a cylinder pressure (rod pressure) of an oil chamber on the rod side of the boom cylinder 7 and a sensor that measures a cylinder pressure (bottom pressure) of an oil chamber on the bottom side. Output of the sensor S7 (i.e., the measurement data of the cylinder pressure of the boom cylinder 7) is taken into the controller 30.

The sensor S8 measures a pressure (cylinder pressure) in the oil chamber of the arm cylinder 8. The sensor S8 includes, for example, a sensor that measures a cylinder pressure (rod pressure) of an oil chamber on the rod side of the arm cylinder 8 and a sensor that measures a cylinder pressure (bottom pressure) of an oil chamber on the bottom side of the arm cylinder 8. Output of the sensor S8 (i.e., the measurement data of the cylinder pressure of the arm cylinder 8) is taken into the controller 30.

The sensor S9 measures a pressure (cylinder pressure) in the oil chamber of the bucket cylinder 9. The sensor S9 includes, for example, a sensor that measures a cylinder pressure (rod pressure) of an oil chamber on the rod side of the bucket cylinder 9 and a sensor that measures a cylinder pressure (bottom pressure) of an oil chamber on the bottom side of the bucket cylinder 9. Output of the sensor S9 (i.e., the measurement data of the cylinder pressure of the bucket cylinder 9) is taken into the controller 30.

The controller 30 can ascertain a state of a load acting on the attachment AT based on the outputs of the sensors S7 to S9. The load acting on the attachment AT includes, for example, a reaction force acting on the bucket 6 from earth and sand on the ground as a work target, a weight of the earth and sand stored in the bucket 6, and the like.

Some or all of the sensors S1 to S9 may be omitted as necessary. The excavator 100 may be mounted with another sensor capable of ascertaining a state of the excavator 100. For example, the excavator 100 may include an orientation sensor capable of detecting the orientation of the excavator 100. The orientation sensor is, for example, an electronic compass including a geomagnetic sensor.

### (Various Functions of Excavator)

Next, various functions mounted on the excavator 100 will be described.

### <Payload Function>

The excavator 100 has, for example, a payload function.

The payload function is a function of assisting with an operator's operation for loading earth and sand onto a dump truck by the excavator 100.

The loading work is realized by, for example, repetition of a series of the following operations (1-1) to (1-4) by the excavator 100.

### (1-1) Excavating Operation

The excavator 100 operates the attachment AT in response to an operator's operation to excavate earth and sand with the bucket 6 and scoop up the earth and sand into the bucket 6.

### (1-2) Boom Raising Slew Operation

The excavator 100 performs a combined operation of a raising operation of the boom 4 and a slew operation of the upper slewing body 3 in response to an operator's operation, and moves the bucket 6 accommodating the earth and sand to above a loading platform of a dump truck.

### (1-3) Soil Removal Operation

The excavator 100 operates the attachment AT in response to an operator's operation to discharge the earth and sand accommodated in the bucket 6 to the loading platform of the dump truck. Thus, the earth and sand stored in the bucket 6 can be loaded on the loading platform of the dump truck.

### (1-4) Boom Lowering Slew Operation

The excavator 100 performs a combined operation of the lowering operation of the boom 4 and the slew operation of the upper slewing body 3 in response to an operator's operation, and returns the bucket 6 to a position where the earth and sand to be loaded is present.

The payload function is realized by a control mode (hereinafter, referred to as a “payload mode” for convenience) for performing control related to the payload function of the controller 30.

The controller 30 calculates a weight of the earth and sand accommodated in the bucket 6 by the excavation operation in the payload mode. For example, the controller 30 calculates a mass of the earth and sand stored in the bucket 6 based on the outputs of the sensors S7 to S9. Thus, the controller 30 can notify the operator of the weight of the earth and sand accommodated in the bucket 6 through the display apparatus 50A, for example.

In the payload mode, the controller 30 calculates the weight of the earth and sand loaded on the dump truck by integrating an amount of the earth and sand discharged to the bucket 6 by the earth and sand removal operation. Thus, the controller 30 can notify the operator of the weight of the earth and sand that have been loaded on the dump truck since the start of the loading work through the display apparatus 50A, for example.

In addition, the controller 30 calculates a remaining load amount loadable on the dump truck (hereinafter, referred to as a “remaining load amount” for convenience) in the payload mode. Specifically, the controller 30 calculates the remaining load amount of the dump truck by subtracting the weight of the earth and sand loaded on the dump truck from the maximum load amount of the dump truck. Thus, the controller 30 can notify the operator of the remaining load of the dump truck through the display apparatus 50A, for example.

The maximum load capacity of the dump truck is set, for example, based on an instruction, such as a cab type or a size of the dump truck that is input from a user, through the input apparatus 52. The maximum load capacity of the dump truck may be set by a user inputting a numerical value through the input apparatus 52. The controller 30 may detect a dump truck in the vicinity of the excavator 100 based on an image captured by the imaging device 40 and specify a vehicle type, a size, and the like from the detected dump truck to estimate the maximum load capacity of the dump truck.

### <Crane Function>

The excavator 100 has, for example, a crane function.

The crane function is a function of supporting an operator's operation for crane work of suspending a suspended load from the hook HK of the excavator 100 and moving the suspended load.

The crane work is realized by, for example, the following operations (2-1) to (2-6) performed by the excavator 100 and the workers in the vicinity of the excavator 100.

### (2-1) Preparation Operation

The excavator 100 operates at least one of the lower travel body 1, the upper slewing body 3, and the attachment AT in response to an operator's operation, and moves the hook HK to a position at a predetermined height directly above the suspended load. At this time, the operator's operation is guided by workers in the vicinity of the excavator 100.

### (2-2) Slinging Operation (Load Hanging Work)

The worker hangs a slinging tool for a suspended load on the hook HK.

### (2-3) Lifting Operation

The excavator 100 operates the attachment AT in response to an operator's operation to lift the suspended load to a predetermined height.

### (2-4) Moving Operation

The excavator 100 operates the lower travel body 1 or the upper slewing body 3 in response to an operator's operation to move the suspended load to a position above a predetermined position. At this time, the operator's operation is guided by workers in the vicinity of the excavator 100.

### (2-5) Hanging Down Operation

The excavator 100 operates the attachment AT in response to an operator's operation to lower the suspended load onto the ground. At this time, the operator's operation is guided by workers in the vicinity of the excavator 100.

### (2-6) Slinging Operation (Load Removing Operation)

The worker removes the slinging tool of the suspended load from the hook HK.

The crane function is realized by a control mode (hereinafter, a “lift mode” for convenience) for performing control related to the crane function of the controller 30.

The controller 30 prohibits the opening operation of the bucket 6 in the lift mode. Thus, the controller 30 can prevent the bucket 6 from performing the opening operation during the crane operation.

In addition, the controller 30 limits the operation speed of the hydraulic actuator HA in the lift mode. Specifically, the controller 30 sets the operation speed of the attachment with respect to the operation of the hydraulic actuator HA to be lower than that in the normal mode. The normal mode is a standard control mode of the controller 30. Thus, the controller 30 can suppress the occurrence of large swinging, dropping, or the like of the suspended load during the crane work.

In the lift mode, the controller 30 calculates a load state of the excavator 100 relating to the suspended load and causes the display apparatus 50A in the cab 10 to display the calculation result. Thus, an operator of the cab 10 can proceed with the crane work while ascertaining the load state of the excavator 100 relating to the suspended load.

The load state of the excavator 100 is divided into a plurality of stages, for example, and is defined by a load (weight) W of the suspended load. The load W of the suspended load is measured based on the outputs of the sensors S7 to S9 as described above. Specifically, the load state of the excavator 100 may be defined by a first stage, a second stage, and a third stage in an ascending order. The first stage represents a state in which the load W of the suspended load is smaller than a threshold value Wth1. The threshold value Wth1 is defined in advance as a value smaller than the rated load Wlim defined in advance. The second stage represents a state where the load W of the suspended load is equal to or larger than the threshold value Wth1 and smaller than a threshold value Wth2. The threshold value Wth2 is defined in advance as a value that is larger than the threshold value Wth1 and smaller than the rated load Wlim. The third stage represents a state where the load W of the suspended load is equal to or more than the threshold value Wth2.

Note that the load state of the excavator 100 may be determined in consideration of not only a load of the suspended load but also a posture state of the attachment AT. The posture state of the attachment AT is measured based on the outputs of the sensors S1 to S5 as described above. For example, the controller 30 may calculate an overturning moment of the excavator 100 from the load of the suspended load and the posture state of the attachment, and may calculate a load state of the excavator 100 relating to the suspended load based on a magnitude of the overturning moment.

In the lift mode, the controller 30 changes the color of the light emitted from the external display lamp (not illustrated) in accordance with the load state of the excavator 100 relating to the suspended load. For example, in the case where the load state of the excavator 100 relating to the suspended load is the first stage, the controller 30 controls the external display lamp so that the external display lamp emits green or blue light. In the case where the load state of the excavator 100 relating to the suspended load is the second stage, the controller 30 controls the external display lamp so that the external display lamp emits yellow or orange light. In the case where the load state of the excavator 100 relating to the suspended load is the third stage, the controller 30 controls the external display lamp such that the external display lamp emits red light. Thus, the controller 30 can cause workers in the vicinity of the excavator 100, such as a worker who performs the slinging work of the suspended load, to check the load state of the excavator 100 relating to the suspended load by the color emitted by the external display lamp.

### <Machine Guidance Function and Machine Control Function>

The excavator 100 has, for example, a machine guidance function and a machine control function.

The machine guidance function and the machine control function are functions for assisting with an operator's operation with respect to a target shape of a construction of a work target of the excavator 100. The target shape of the construction of the work target is, for example, a target construction surface defined in advance.

Specifically, in the machine guidance function, information regarding a relative position, a relative posture state, and the like of the work part of the attachment AT with respect to the target shape of the work target is provided to an operator through the output apparatus 50.

In addition, in the machine control function, the excavator 100 automatically or semi-automatically operates the attachment AT so as to realize the target shape of the work target. In the machine control function, the lower travel body 1 and the upper slewing body 3 may be automatically or semi-automatically operated in addition to the attachment AT.

Note that the semi-automatic operation includes, for example, a mode in which a hydraulic actuator HA operates in conjunction with a certain hydraulic actuator HA in response to an operator's operation of the certain hydraulic actuator HA, whereby the attachment AT operates so as to realize the target shape of the work target. The semi-automatic operation may include an aspect in which an attachment AT operates to realize the target shape of the work target by appropriately correcting an operation of an attachment AT from an operation corresponding to an operator's operation on the premise that the attachment AT is operated by an operator.

The machine control function and the machine guidance function are realized by a control mode (hereinafter, referred to as an “MC-MG mode” for convenience) for performing control related to the machine control function and the machine guidance function in the controller 30.

For example, the controller 30 provides the machine guidance function at all times in the MC-MG mode. In addition, in the MC-MG mode, the controller 30 provides the machine control function in the case where an input requesting the provision of the machine control function is received from an operator through the input apparatus 52.

In the MC-MG mode, the controller 30 measures the distance between the working site of the attachment AT, that is, a reference point of the bucket 6 and a target construction surface, and notifies an operator of the distance through the output apparatus 50. The reference point of the bucket 6 is, for example, a point corresponding to the claw tip of the bucket 6. The reference point of the bucket 6 is a predetermined point on the flat portion of the back surface of the bucket 6. The reference point of the bucket 6 may be changed according to content of work.

In addition, the controller 30 measures a posture state of the work part (bucket 6) of the attachment AT with respect to the target construction surface in the MC-MG mode, and notifies the operator of the posture state through the output apparatus 50.

In addition, in the MC-MG mode, when the machine control function is enabled, the controller 30 operates the attachment AT or the like in response to an operator's operation or automatically so that the reference point of the bucket 6 moves along a target trajectory.

The target trajectory is defined, for example, along the target construction surface. The target trajectory may be defined based on a comparison between the target construction surface and the shape of the ground of the current work target. The shape of the ground surface of the current work target is acquired based on, for example, the image of the imaging device 40. For example, in the case where the difference between the target construction surface and the shape of the ground of the current work target is equal to or larger than a predetermined reference, a target trajectory of rough excavation is defined so as to reduce the difference between the ground of the work target and the target construction surface. On the other hand, in the case where the difference between the target construction surface and the shape of the ground surface of the current work target is less than the predetermined reference, the target trajectory is defined to be along the target construction surface.

### (Method of Switching Control Mode)

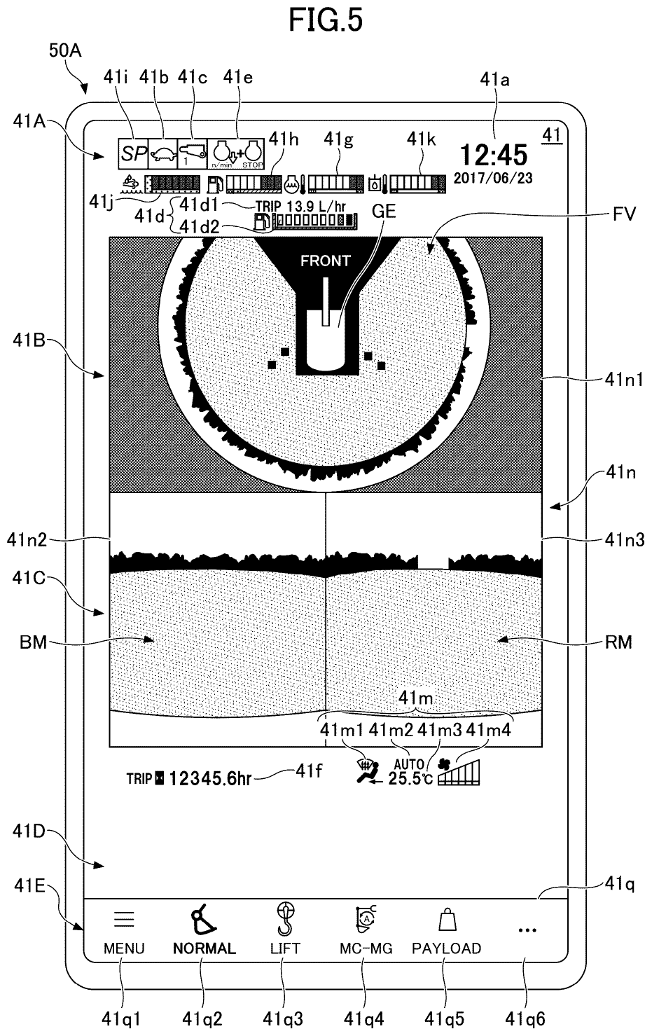

Next, a method of switching a control mode of the controller 30, specifically, an operation method in which an operator selects a control mode of the controller 30 from among a plurality of control modes will be described with reference to FIGS. 5 to 8. In the present example, the description will be made on the assumption that the controller 30 has four or more control modes including the normal mode, the payload mode, the lift mode, and the MC-MG mode described above.

The number of control modes of the controller 30 may be two or three.

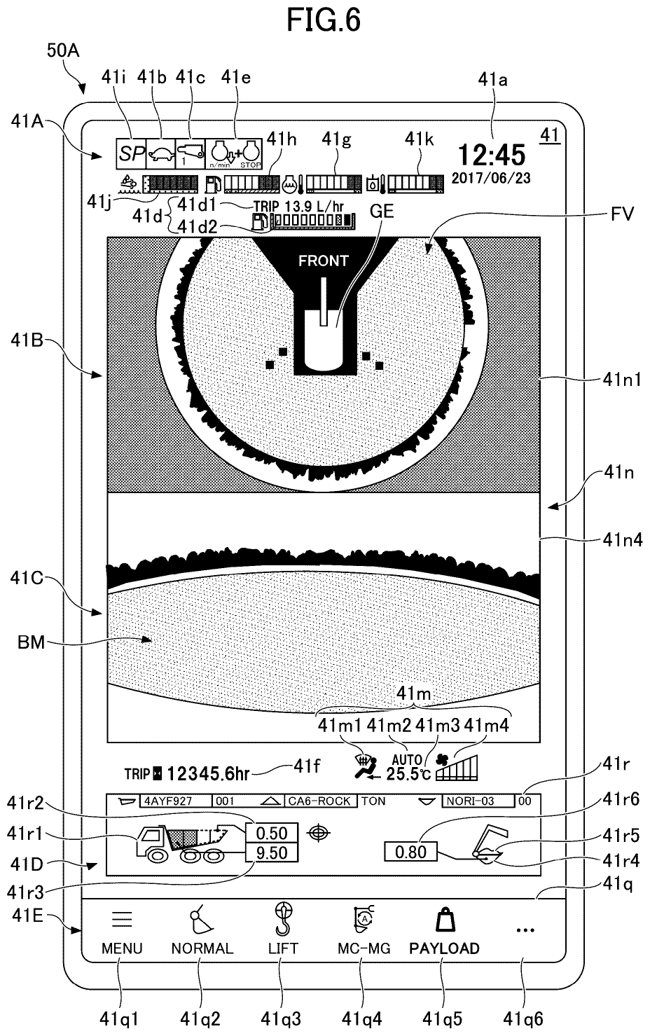

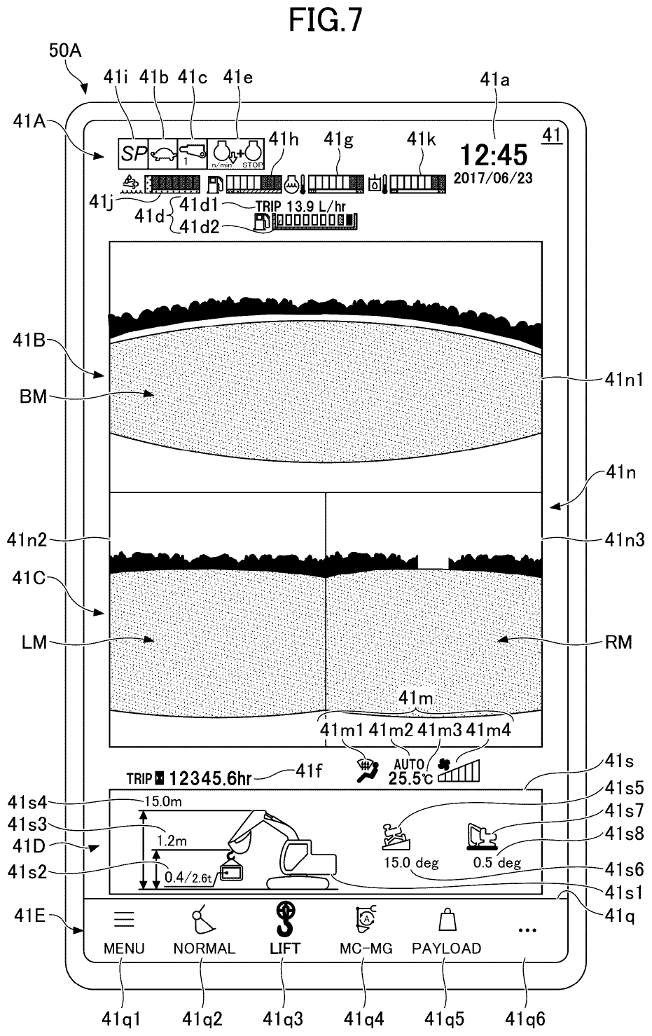

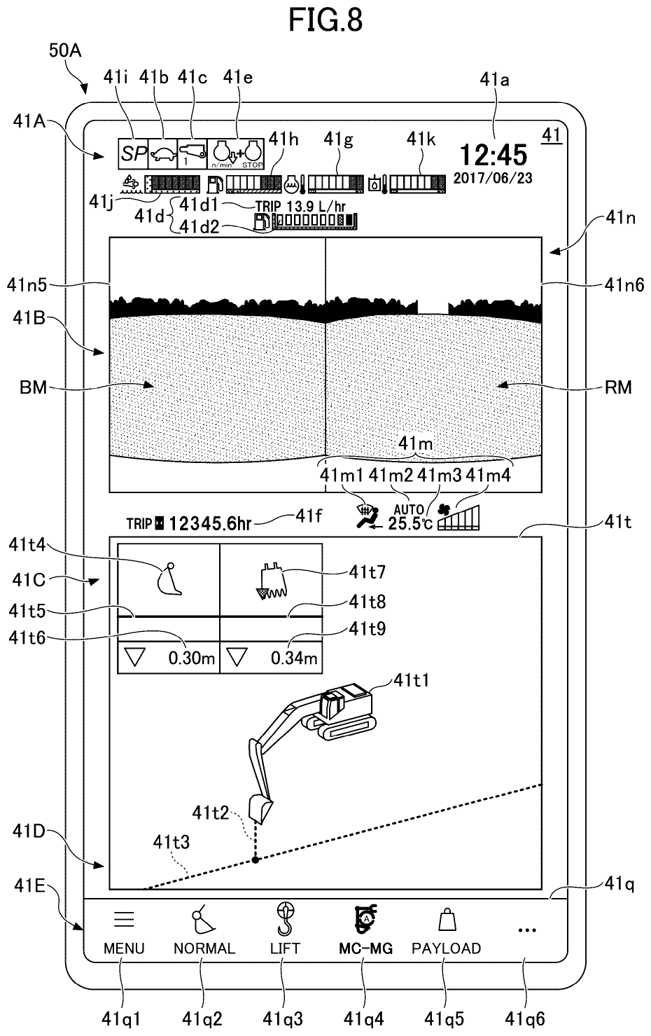

FIGS. 5 to 8 are diagrams illustrating first to fourth examples of a screen 41 of the display apparatus 50A. Specifically, FIG. 5 is a diagram illustrating an example of the screen 41 of the display apparatus 50A in the case where the control mode of the controller 30 is the normal mode. FIG. 6 is a diagram illustrating an example of the screen 41 of the display apparatus 50A in the case where the control mode of the controller 30 is the payload mode. FIG. 7 is a diagram illustrating an example of the screen 41 of the display apparatus 50A in the case where the control mode of the controller 30 is the lift mode. FIG. 8 is a diagram illustrating an example of the screen 41 of the display apparatus 50A in the case where the control mode of the controller 30 is the MC-MG mode.

The display processing regarding the display apparatus 50A, the detection processing regarding an operation state of the screen 41 of the display apparatus 50A, and the like are performed under the control of the controller 30, for example. The display processing regarding the display apparatus 50A, the detection processing regarding an operation state of the screen 41 of the display apparatus 50A, and the like may be performed by a control device built in the display apparatus 50A.

### <Method of Screen Use>

As illustrated in FIGS. 5 to 8, the screen 41 includes display areas 41A to 41E.

The display areas 41A to 41E are arranged in this order, from the top.

The display area 41A is arranged in an upper portion of the screen 41. In the display area 41A, fixed display content is displayed regardless of the control mode selected by the controller 30.

The display area 41A includes information display areas 41a to 41e and 41g to 41k.

The current date and time is displayed in the information display area 41a. The currently selected travel mode of the excavator 100 is displayed in the information display area 41b. In the information display area 41c, an image representing the end attachment currently attached is displayed. Information regarding a fuel consumption rate (fuel efficiency) of the excavator 100 is displayed in the information display area 41d. The information display area 41d includes, for example, an information display area 41d1 in which lifetime average fuel efficiency or section average fuel efficiency is displayed and an information display area 41d2 in which instantaneous fuel efficiency is displayed. Information indicating a control state of the engine 11 is displayed in the information display area 41e.

The information display area 41g displays a current temperature state of a coolant of the engine 11. The information display area 41h displays a remaining amount of a fuel stored in the fuel tank. The information display area 41i displays a work mode corresponding to a rotational speed of the engine 11. The information display area 41j displays a remaining amount of urea-water stored in a urea-water tank. The temperature state of a hydraulic oil of the hydraulic drive system is displayed in the information display area 41k.

The display areas 41B to 41D are arranged in the center portion of the screen 41 in the vertical direction. In the display areas 41B to 41D, fixed display content unique to the control mode selected by the controller 30 is displayed. The display content unique to each of the plurality of control modes may be fixed or may be changeable in response to a request that is input from a user through the input apparatus 52. The details of the display content will be described later.

The display area 41E is arranged in a lower portion of the screen 41. In the display area 41E, fixed display content is displayed regardless of the control mode selected by the controller 30. Specifically, in the display area 41E, a tab group 41q of operation elements for selecting one control mode to be applied to the controller 30 from among a plurality of control modes is displayed. For example, an operator can perform an operation of the tab group 41q by using the touch panel 80 as the input apparatus 52. The operator may be able to operate the tab group 41q by using switches attached to the display apparatus 50A as the input apparatus 52.

Hereinafter, among the display areas 41A to 41E, the display areas 41A and 41E that do not depend on the control mode of the controller 30 may be referred to as “fixed display areas” for convenience, and the display areas 41B to 41D that depend on the control mode may be referred to as “variable display areas” for convenience.

The tab group 41q includes tabs 41q1 to 41q6. The tabs 41q1 to 41q6 are arranged in the left-right direction in order from the left.

The tab 41q1 is an operation icon for performing setting related to the screen 41.

For example, the setting related to the screen 41 includes setting related to the tab group 41q. The setting related to the tab group 41q includes, for example, setting of the arrangement order of the operation icons corresponding to the four control modes arranged in the tabs 41q2 to 41q5. Thus, an operator can customize the arrangement order of the operation icons corresponding to the four control modes, which are arranged in the tabs 41q2 to 41q5. The position of the operation icon corresponding to the normal mode may be fixed to the tab 41q2. In this case, an operator can customize the arrangement order of the operation icons corresponding to the three control modes, which are arranged in the tabs 41q3 to 41q5. The setting related to the tab group 41q may include setting related to the specifications of a cursor indicating the control mode of the selected controller 30. For example, as illustrated in FIGS. 5 to 8, the cursor is realized by highlighting an operation icon corresponding to a selected control mode, but may be realized by a rectangular frame or the like surrounding the operation icon by changing the setting. In the case where there are four or more control modes, the setting related to the tab group 41q includes a setting for selecting four control modes corresponding to four operation icons arranged in the tabs 41q2 to 41q5 from among a plurality of control modes. For example, as illustrated in FIGS. 5 to 8, the operation icons corresponding to the payload mode, the lift mode, and the MC-MG mode are displayed on the tabs 41q3 to 41q5; some or all of the operation icons may be, however, changed to operation icons corresponding to other control modes. The operation icon corresponding to the normal mode may be included in the tabs 41q2 to 4195 without fail. In this case, an operator can customize three control modes corresponding to three operation icons other than the operation icon corresponding to the normal mode, which are arranged in the tabs 41q2 to 41q5.

The setting related to the screen 41 may include setting of specifications related to display contents of the variable display area (i.e., the display area 41B to the display area 41D) of the screen 41 for each control mode.

For example, in response to a selection operation of the tab 41q1, a plurality of operation icons corresponding to a plurality of executable setting contents are laid out in the tab group 41q so as to be adjacent to each other. Thus, an operator can perform a desired setting operation by performing an operation of selecting one operation icon from the laid-out operation icons, using the touch panel 80 or the like.

The tabs 41q2 to 41q5 are operation icons corresponding to four control modes among the plurality of control modes. Thus, an operator can select one control mode to be applied to the controller 30 from among the plurality of control modes by performing an operation of selecting and confirming any one of the tabs 41q2 to 41q5, using the touch panel 80 or the like.

In the present example, an operation icon corresponding to the normal mode is displayed on the tab 41q2. An operator can select the normal mode from among the plurality of control modes as the control mode applied to the controller 30 by operating the tab 41q2, using the touch panel 80.

In the present example, an operation icon corresponding to the lift mode is displayed on the tab 41q3. Thus, an operator can select the lift mode from among the plurality of control modes as the control mode applied to the controller 30 by operating the tab 41q3, using the touch panel 80.

In the present example, an operation icon corresponding to the MC-MG mode is displayed on the tab 41q4. Thus, an operator can select the MC-MG mode from among the plurality of control modes as the control mode applied to the controller 30 by operating the tab 41q4, using the touch panel 80.

In the present example, an operation icon corresponding to the payload mode is displayed on the tab 41q5. Thus, an operator can select the payload mode from among the plurality of control modes as the control mode applied to the controller 30 by operating the tab 41q5, using the touch panel 80.

The tab 41q6 displays an operation icon corresponding to another control mode different from the four control modes corresponding to the operation icons of the tabs 41q2 to 41q5, in the case where there are four or more control modes. Accordingly, an operator can select another control mode different from the four control modes corresponding to the operation icons of the tabs 41q2 to 41q5 among the plurality of control modes by performing an operation of selecting the tab 41q6, using the touch panel 80 or the like.

For example, in response to a selection operation of the tab 41q6, the operation icons corresponding to the other control modes different from the four control modes corresponding to the operation icons of the tabs 41q2 to 41q5 are laid out to be adjacent to each other in the tab group 41q. Accordingly, an operator can select another control mode different from the four control modes corresponding to the operation icons of the tabs 41q2 to 41q5 by performing an operation of selecting one operation icon from the laid-out operation icons, using the touch panel 80 or the like.

For example, in the case where another control mode corresponding to the tab 41q6 is selected as the control mode applied to the controller 30, the operation icon of the tab 41q6 is changed to an operation icon corresponding to the other control mode selected from the states illustrated in FIGS. 5 to 8. Then, the cursor is aligned with the tab 41q6. Thus, a user can check the control mode being applied to the controller 30 through the operation icon of the tab 41q6.

As described above, in the present example, an operator can select a control mode to be applied to the controller 30 by operating the tabs 41q2 to 41q6 of the tab group 41q displayed in the fixed display area (display area 41E) of the screen 41, using the touch panel 80 or the like. Therefore, an operator can easily switch the control mode of the controller 30 in accordance with work content or the like in the same screen 41. Therefore, the excavator 100 can improve the convenience of a user and the work efficiency.

### <Other Methods>

An operator may be able to perform an operation of selecting a control mode to be applied to the controller 30 from among a plurality of control modes by another method different from the method in which the screen 41 is used.

For example, an operator may be able to perform an operation of selecting a control mode to be applied to the controller 30 by a pressing operation of the dial 82A.

Specifically, the controller 30 may switch a control mode applied to itself in a predetermined order from among the plurality of control modes each time the dial 82A is pressed.

At this time, in response to the switching of the control mode by the pressing operation on the dial 82A, the controller 30 switches the display content of the screen 41 to the display content corresponding to the control mode after the switching. Specifically, at the time of switching the control mode applied to the controller 30 through a pressing operation of the dial 82A, the controller 30 switches the display content of the variable display area of the screen 41 to the content unique to the control mode after the switching. At the time of switching the control mode applied to the controller 30 in response to a pressing operation on the dial 82A, the controller 30 sets the cursor to, among the tabs 41q2 to 41q6, the operation icon corresponding to the control mode after the switching.

In this way, in the present example, an operator can select a control mode to be applied to the controller 30 from among a plurality of control modes by using a pressing operation of the dial 82A or the like. Therefore, since there are a plurality of options when the control mode of the controller 30 is switched, it is possible to improve the convenience of the operator.

In this example, the controller 30 can cause the display content of the screen 41 to be linked to the switching of the control mode of the controller 30 in response to a pressing operation on the dial 82A or the like.

### <Method for Selecting Control Mode at Time of Activation of Excavator>

At the time of activation of the excavator 100, an operator cannot select the control mode applied to the controller 30, using the screen 41 or the dial 82A. For this reason, the controller 30 automatically selects one control mode from a plurality of control modes to activate the excavator 100.

For example, at the time of activating the excavator 100, the controller 30 automatically selects the control mode that was applied to the controller 30 at the time when the excavator 100 was last stopped, and activates the excavator 100. Thus, an operator can start the work in the same control mode as the previous control mode. Therefore, the controller 30 can improve the convenience and work efficiency of an operator.

At the time of activation of the excavator 100, the controller 30 may automatically select and activate one control mode that is set in advance among the plurality of control modes. The control mode that is set in advance may be fixed or may be changed by an operator through the input apparatus 52.

### (Screen Corresponding to Normal Mode)

Next, the screen 41 corresponding to the normal mode will be described with reference to FIG. 5.

In the following, in the present example, the description will focus on display content of the variable display area (display areas 41B to 41D) in which display content unique to the normal mode corresponding to the control mode being applied to the controller 30 is displayed.

The surrounding image display area 41n is displayed in the display areas 41B and 41C.

An image (hereinafter, referred to as a “surrounding image”) representing the state of the surroundings of the excavator 100 based on the captured image of the imaging device 40 is displayed in the surrounding image display area 41n. The surrounding image display area 41n includes surrounding image display areas 41n1 to 41n3.

The surrounding image display area 41n1 is displayed in the display area 41B so as to be adjacent below the information display area 41d included in the display area 41A.

In the present example, the surrounding image display area 41n1 displays a bird's-eye view image FV of the surroundings of the excavator 100 viewed from above, which is generated based on the captured image of the imaging device 40. In the surrounding image display area 41n1, an excavator image GE, which is a simulative top view of the excavator 100, is displayed. The excavator image GE and the bird's-eye view image FV are arranged in the surrounding image display area 41n1, in such a manner that the positional relationship therebetween coincides with the positional relationship between the excavator 100 and the imaging range included in the bird's-eye view image FV.

The surrounding image display areas 41n2 and 41n3 are displayed in the display area 41C so as to be adjacent below the surrounding image display area 41n1. The surrounding image display area 41n2 and the surrounding image display area 41n3 are arranged adjacent in the left side and the right side of the display area 41C respectively, with reference to the center of the display area 41C in the left-right direction.

In the present example, a rear image BM representing a state behind the excavator 100 is displayed in the surrounding image display area 41n2, and a right image RM representing a state to the right of the excavator 100 is displayed in the surrounding image display area 41n3. The rear image BM and the right image RM correspond to the captured images of the camera 40B and the camera 40R, respectively.

The display area 41D includes information display areas 41f and 41m.

The information display area 41f is arranged so as to be adjacent below the surrounding image display area 41n2. The information display area 41f displays a cumulative operating time of the engine 11.

The information display area 41m is arranged so as to be adjacent below the surrounding image display area 41n3, and rightward of the information display area 41f. The information display area 41m displays an operation state of the air conditioner. The information display area 41m includes information display areas 41m1 to 41m4.

In the information display area 41m1, the position of the air outlet currently used for blowing air from the air conditioner is displayed. A current operation mode of the air conditioner is displayed in the information display area 41m2. A current setting temperature of the air conditioner is displayed in the information display area 41m3. A current airflow setting of the air conditioner is displayed in the information display area 41m4.

In this example, the normal mode is selected as a control mode applied to the controller 30 from among the plurality of control modes. For this reason, the cursor is placed on the tab 41q2 in the tab group 41q on which the operation icon corresponding to the normal mode is displayed. Thus, an operator can confirm that the normal mode is selected.

The display content of the variable display area corresponding to the normal mode, specifically, the type, arrangement, and the like of information to be displayed may be changeable in accordance with a predetermined input that is input by an operator through the input apparatus 52. Specifically, the controller 30 may change the setting of the display content of the variable display area in response to an operation on the tab 41q1 through the touch panel 80. For example, the display content of the surrounding image display area 41n, in particular, the type and arrangement of the surrounding image included in the surrounding image display area 41n may be discretionarily determined. Hereinafter, the display content of the variable display areas corresponding to other control modes may be changed in the same manner.

### (Screen Corresponding to Payload Mode)

Next, the screen 41 corresponding to the payload mode will be described with reference to FIG. 6.

In the following, in the present example, the description will focus on display content of the variable display area (display areas 41B to 41D) in which display content unique to the payload mode corresponding to the control mode being applied to the controller 30 is displayed. In the present example, the description will focus on portions of the display content that differ from display content identical to or corresponding to that of the screen 41 corresponding to the normal mode, and the description of the same or corresponding display content may be omitted.

As illustrated in FIG. 6, the surrounding image display area 41n is displayed in the display areas 41B and 41C, similarly to the case of the normal mode.

The surrounding image display area 41n includes surrounding image display areas 41n1 to 41n4.

The excavator image GE and the bird's-eye view image FV are displayed in the surrounding image display area 41n1, similarly to the case of the normal mode.

The surrounding image display area 41n4 is displayed in the display area 41C so as to be adjacent below the surrounding image display area 41n1. The surrounding image display area 41n4 corresponds to a display area obtained by combining the surrounding image display areas 41n2 and 41n3 in the case of the normal mode. The rear image BM is displayed in the surrounding image display area 41n4.

The display area 41D includes information display areas 41f, 41m, and 41r.

The information display areas 41f and 41m are arranged so as to be adjacent below the surrounding image display area 41n4.

The information display area 41r is arranged below the information display areas 41f and 41m and above the tab group 41q. Information related to the payload mode is displayed in the information display area 41r. The information display area 41r includes a dump truck image 41r1, numerical information images 41r2 and 41r3, a bucket image 41r4, an earth and sand image 41r5, and a numerical information image 41r6.

The dump truck image 41r1 is an image that simulates a side view of the dump truck. In the platform portion in the side view of the dump truck in the dump truck image 41r1, an image of a bar graph representing a load amount of the platform of the dump truck is displayed. The bar graph represents a ratio of a loading amount of earth and sand loaded on the platform of the dump truck to a maximum loading amount of the dump truck. Thus, an operator can intuitively ascertain the loading state of the earth and sand on the dump truck.

The numerical information image 41r2 is a numerical value indicating a remaining load amount of the platform of the dump truck, and the numerical information image 41r3 is a numerical value indicating a load amount of earth and sand loaded on the platform of the dump truck. The numerical value displayed as the numerical information image 41r2 corresponds to a value obtained by subtracting a load amount corresponding to the numerical information image 41r3 from a maximum load amount of the platform of the dump truck. Thus, an operator can ascertain the loading state of the earth and sand on the dump truck with specific numerical values.

The bucket image 41r4 is an image that simulatively represents a state in which the bucket 6 is scooping up the earth and sand. The earth and sand image 41r5 is drawn so as to be adjacent above the opening of the bucket 6. The earth and sand image 41r5 is displayed in the case where the earth and sand is stored in the bucket 6, and is not displayed in the case where the earth and sand is not stored in the bucket 6.

The numerical information image 41r6 is a numerical value representing a mass of a load (for example, earth and sand) inside the bucket 6. Thus, an operator can ascertain the weight of the earth and sand inside the bucket 6 before the earth and sand is discharged.

In the case where an amount of the load in the bucket 6 corresponding to the numerical information image 41r6 is larger than a remaining load amount of the dump truck corresponding to the numerical information image 41r2, the display mode of the information display area 41r may be changed. For example, the color of at least a part of the dump truck image 41r1, the numerical information images 41r2 and 41r3, the bucket image 41r4, the earth and sand image 41r5, and the numerical information image 41r6 is changed to red. Thus, the controller 30 can make an operator surely ascertain that there is a possibility of overload when the earth and sand in the bucket 6 is discharged to the loading space of the dump truck.

In this example, the payload mode is selected as a control mode applied to the controller 30 from among the plurality of control modes. For this reason, the cursor is placed on the tab 41q5 in the tab group 41q on which the operation icon corresponding to the payload mode is displayed. Thus, an operator can confirm that the payload mode is selected.

### (Screen Corresponding to Lift Mode)

The screen 41 corresponding to the lift mode will be described with reference to FIG. 7.

In the following, in the present example, the description will focus on display content of the variable display area (display areas 41B to 41D) in which display content unique to the lift mode corresponding to the control mode being applied to the controller 30 is displayed. In the present example, the description will focus on portions of the display content that differ from display content identical to or corresponding to that of the screens 41 corresponding to the normal mode and payload mode, and the description of the same or corresponding display content may be omitted.

As illustrated in FIG. 7, the surrounding image display area 41n is displayed in the display areas 41B and 41C, similarly to the case of the normal mode.

The surrounding image display area 41n includes the surrounding image display areas 41n1 to 41n3, similarly to the case of the normal mode.

The rear image BM is displayed in the surrounding image display area 41n1.

A left image LM and a right image RM are displayed in the surrounding image display area 41n2 and the surrounding image display area 41n3, respectively. The left image LM corresponds to a captured image of the camera 40L.

The display area 41D includes information display areas 41f, 41m, and 41s.

The information display areas 41f and 41m are arranged below and adjacent to the surrounding image display areas 41n2 and 41n3, respectively, similarly to the case of the normal mode.

The information display area 41s is arranged below the information display areas 41f and 41m and above the tab group 41q. Information related to the lift mode is displayed in the information display area 41s. The information display area 41s includes an excavator image 41s1, numerical information images 41s2 to 41s4, an excavator image 41s5, a numerical information image 41s6, an excavator image 41s7, and a numerical information image 41s8.

The excavator image 41s1 is an image that simulatively represents the excavator 100 during crane work. An image portion corresponding to a suspended load of the excavator image 41s1 (hereinafter, referred to as a “suspended load image”) may represent a load state of the excavator 100 due to the suspended load by a color. For example, in the case where the load state of the excavator 100 due to the suspended load is in the first stage, the suspended load image is displayed in green or blue; in the case where the load state is in the second stage, the suspended load image is displayed in yellow or orange; in the case where the load state is in the third stage, the suspended load image is displayed in red. Thus, an operator can proceed with the crane work while ascertaining the load state of the excavator 100 relating to the suspended load.

The numerical information image 41s2 is a numerical value representing a load of a suspended load. In the present example, the numerical value (“0.4”) indicating the load of the suspended load and the numerical value (“2.6 t”) indicating a rated load are displayed in the numerical information image 41s2. Thus, an operator can ascertain the load state of the excavator 100 due to the load of the suspended load as a specific numerical value while using the rated load as a reference. Thus, an operator can ascertain the load state of the excavator 100 due to the load of the suspended load as a specific numerical value while using the rated load as a reference.

The numerical information image 41s3 is a numerical value indicating the height position of the hook HK. The numerical information image 41s4 is a numerical value indicating the height position of the highest portion of the attachment AT. Thus, an operator can proceed with crane work while checking the height position of the suspended load and the height position of the highest portion of the attachment AT. The height position of the hook HK and the height position of the highest portion of the attachment AT are measured based on the outputs of the sensors S1 to S5.

The excavator image 41s5 is an image that simulatively represents a state of the excavator 100 viewed from the rear. The excavator image 41s5 is inclined in the left-right direction in conjunction with an inclination state of the excavator 100 in the left-right direction. In this example, the excavator image 41s5 is inclined downward to the left in conjunction with the state in which the excavator 100 is inclined downward to the left by 15 degrees. Thus, an operator can intuitively ascertain an inclination state of the excavator 100 in the left-right direction.

The numerical information image 41s6 is a numerical value indicating an inclination state of the excavator 100 in the left-right direction. Thus, an operator can ascertain an inclination state of the excavator 100 in the left-right direction as a specific numerical value.

The excavator image 41s7 is an image that simulatively represents a state of the excavator 100 viewed from the left. The excavator image 41s7 is inclined in the front-rear direction in conjunction with an inclination state of the excavator 100 in the front-rear direction. Thus, an operator can intuitively ascertain an inclination state of the excavator 100 in the front-rear direction.

The numerical information image 41s8 is a numerical value indicating an inclination state of the excavator 100 in the front-rear direction. Thus, an operator can ascertain an inclination state of the excavator 100 in the front-rear direction as a specific numerical value.

In this example, the lift mode is selected as a control mode applied to the controller 30 from among the plurality of control modes. For this reason, the cursor is placed on the tab 41q in the tab group 41q3 on which the operation icon corresponding to the lift mode is displayed. Thus, an operator can confirm that the lift mode is selected.

### (Screen Corresponding to MC-MG Mode)

Next, the screen 41 corresponding to the MC-MG mode will be described with reference to FIG. 8.

In the following, in the present example, the description will focus on display content of the variable display area (display areas 41B to 41D) in which display content unique to the MC-MG mode corresponding to the control mode being applied to the controller 30 is displayed. In the present example, the description will focus on portions of the display content that differ from display content identical to or corresponding to that of the screens 41 corresponding to the normal mode, the payload mode, and the lift mode, and the description of the same or corresponding display content may be omitted.

As illustrated in FIG. 8, a surrounding image display area 41n is displayed in the display area 41B.

The surrounding image display area 41n includes surrounding image display areas 41n5 to 41n6.

The surrounding image display areas 41n5 and 41n6 are provided adjacent below the information display area 41d.

The surrounding image display area 41n5 and the surrounding image display area 41n6 are arranged adjacent in the left side and the right side of the display area 41B respectively, with reference to the center of the display area 41B in the left-right direction.

The rear image BM is displayed in the surrounding image display area 41n5, and the right image RM is displayed in the surrounding image display area 41n6.

The display areas 41C and 41D include information display areas 41f, 41m, and 41t.

The information display area 41f is arranged in the display area 41C so as to be adjacent below the surrounding image display area 41n5. The information display area 41m is arranged in the display area 41C so as to be adjacent below the surrounding image display area 41n6.

The information display area 41t is arranged to extend over the display areas 41C and 41D so as to be adjacent below the information display areas 41f and 41m. Information relating to the machine guidance function and the machine control function is displayed in the information display area 41t. The information display area 41t includes an excavator image 41t1, auxiliary lines 41t2 and 41t3, a bucket image 41t4, a target line 41t5, a numerical information image 41t6, a bucket image 41t7, a target line 41t8, and a numerical information image 41t9.

The excavator image 41t1 is an image of a three-dimensional model that simulatively represents the excavator 100. The excavator image 41t1 is drawn so as to be in the same posture state as the actual posture state of the excavator 100. Thus, an operator can three-dimensionally ascertain a posture state of the excavator 100.

The auxiliary line 41t2 corresponds to a line segment vertically drawn from the reference point of the bucket 6 of the excavator 100 to the target construction surface. The auxiliary line 41t3 corresponds to a straight line that passes through an intersection between a line segment vertically drawn from the reference point of the bucket 6 of the excavator 100 to the target construction surface and the target construction surface, and extends in the front-rear direction of the excavator 100. The excavator image 41t1 and the auxiliary lines 41t2 and 41t3 are drawn so as to match the actual positional relationship between the excavator 100 and the target construction surface. Thus, an operator can three-dimensionally ascertain a positional relationship between the bucket 6 as the work part of the excavator 100 and the target construction surface.

The bucket image 41t4 is an image representing the bucket 6 in a simulated manner as viewed from the left side. The target line 41t5 is a line segment representing the target construction surface when the bucket 6 is viewed from the left side. The bucket image 41t4 and the target line 41t5 are drawn so as to match the actual positional relationship between the bucket 6 and the target construction surface. Thus, an operator can ascertain a positional relationship between the bucket 6 and the target construction surface when viewed from the left side.

The numerical information image 41t6 is a numerical value indicating a vertical distance between a reference point of the claw tip of the left end portion of the bucket 6 and the target construction surface. Thus, an operator can ascertain a distance between the bucket 6 and the target construction surface as a specific numerical value.

The bucket image 41t7 is an image representing the bucket 6 in a simulated manner as viewed from the rear side. The target line 41t8 is a line segment representing the target construction surface when the bucket 6 is viewed from the rear side. The bucket image 41t7 and the target line 41t8 are drawn so as to match the actual positional relationship between the bucket 6 and the target construction surface. Thus, an operator can ascertain a positional relationship between the bucket 6 and the target construction surface when viewed from the rear. An operator can ascertain an inclination state of the bucket 6 in the left-right direction with respect to the target construction surface.

The numerical information image 41t9 is a numerical value indicating a vertical distance between a reference point of the claw tip of the left end portion of the bucket 6 and the target construction surface. Thus, an operator can ascertain a distance between the bucket 6 and the target construction surface as a specific numerical value. An operator can ascertain an inclination state of the bucket 6 in the left-right direction with respect to the target construction surface as a specific numerical value by comparing the numerical information images 41t6 and 41t9.

In this example, the MC-MG mode is selected as a control mode applied to the controller 30 from among the plurality of control modes. For this reason, the cursor is placed on the tab 41q4 in the tab group 41q on which the operation icon corresponding to the MC-MG mode is displayed. Thus, an operator can confirm that the MC-MG mode is selected.

### (Overview of Remote Operation Assistance System)

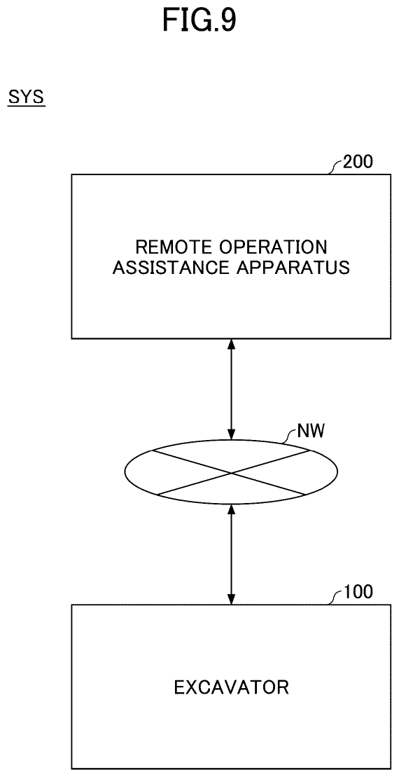

Next, an overview of the remote operation assistance system SYS will be described with reference to FIG. 9.

FIG. 9 illustrates a remote operation assistance system SYS including the excavator 100 and a remote operation assistance apparatus 200.

The remote operation assistance system SYS assists with a remote operation of the excavator 100 through use of the remote operation assistance apparatus 200.

The remote operation assistance apparatus 200 is communicably connected to the excavator 100 through a communication line NW, and is used by an operator who performs a remote operation of the excavator 100.

The remote operation assistance apparatus 200 is provided in, for example, a management center that manages work of the excavator 100 from the outside. Thus, an operator can remotely operate the excavator 100 from a remote place where the operator cannot directly view the excavator 100. The remote operation assistance apparatus 200 may be a portable terminal device for operation. In this case, an operator can remotely operate the excavator 100 while directly checking a work situation of the excavator 100, being in the vicinity of the excavator 100. In this case, the operator can remotely operate the excavator 100 while directly checking the work situation of the excavator 100 from the surroundings of the excavator 100.

The excavator 100 transmits an image (surrounding image) representing a state of surroundings including the region in front of the excavator 100 based on a captured image that is output by the imaging device 40 mounted on the excavator 100 to the remote operation assistance apparatus 200 through the communication device 60, for example. The excavator 100 may transmit the captured image that is output by the imaging device 40 to the remote operation assistance apparatus 200 through the communication device 60, and the remote operation assistance apparatus 200 may process the captured image received from the excavator 100 and generate a surrounding image. Then, the remote operation assistance apparatus 200 causes its own display apparatus 208 to display a surrounding image representing a surrounding situation including the region in front of the excavator 100. The screen including various information images displayed on the output apparatus 50 (display apparatus 50A) inside the cab 10 of the excavator 100 may also be displayed on the display apparatus 208 of the remote operation assistance apparatus 200. Thus, an operator who uses the remote operation assistance apparatus 200 can remotely operate the excavator 100 while checking an image or display content, such as an information screen, that are displayed on the display apparatus 208 and show a situation around the excavator 100. The excavator 100 operates the hydraulic actuator HA in response to a signal indicating content of a remote operation (hereinafter, referred to as a “remote operation signal”) received from the remote operation assistance apparatus 200 through the communication device 60. Specifically, the controller 30 of the excavator 100 outputs a control signal corresponding to a remote operation signal to the hydraulic control valve 31. Thus, the remote operation assistance system SYS can realize a remote operation of the excavator 100 with which the remote operation assistance apparatus 200 is used.

### (Configuration of Remote Operation Assistance Apparatus)

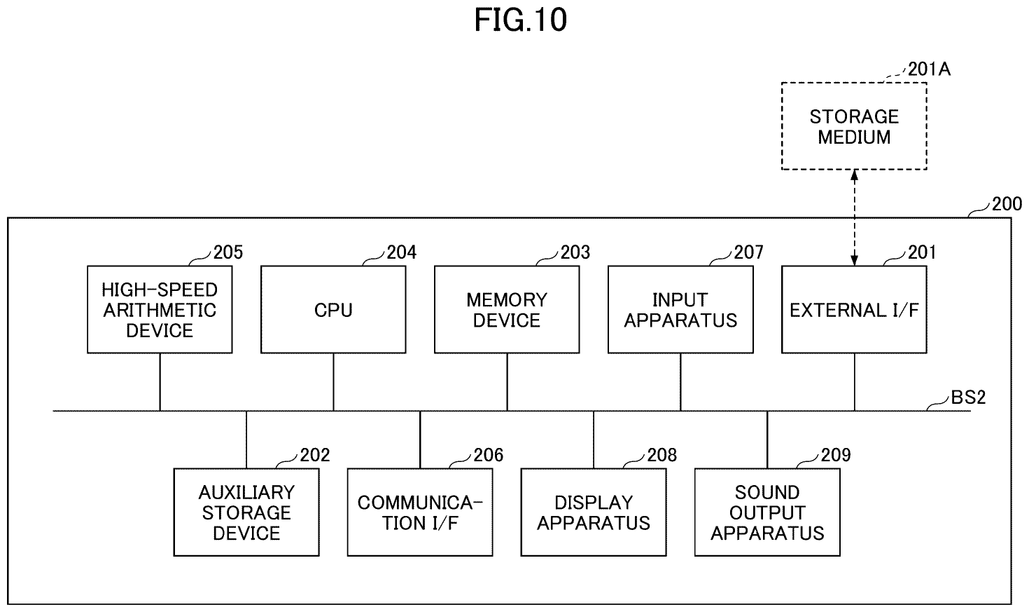

Next, a configuration of the remote operation assistance apparatus 200 will be described with reference to FIG. 10.

FIG. 10 is a diagram illustrating an example of a configuration of the remote operation assistance apparatus 200.

The functions of the remote operation assistance apparatus 200 are realized by arbitrary hardware, a combination of discretionarily selected hardware and software, or the like. For example, as illustrated in FIG. 10, the remote operation assistance apparatus 200 includes an external interface (I/F) 201, an auxiliary storage device 202, a memory device 203, a CPU 204, a high-speed arithmetic device 205, a communication interface (I/F) 206, an input apparatus 207, a display apparatus 208, and a sound output apparatus 209. These are connected to each other by a bus BS2.

The external interface 201 functions as an interface for reading and writing of data from and to a storage medium 201A. The storage medium 201A includes, for example, flexible disks, CDs (compact disc), DVDs (digital versatile disc), BDs (Blu-ray (registered trademark) disc), SD memory cards, USB-type memories, and the like. Thus, the remote operation assistance apparatus 200 can read various kinds of data used in processing and store the data in the auxiliary storage device 202, and can install programs for realizing various functions, through the storage medium 201A.

The remote operation assistance apparatus 200 may acquire various data and programs used in processing from an external apparatus via the communication interface 206.

The auxiliary storage device 202 stores the installed various programs, and also stores files, data, and the like necessary for various processes. The auxiliary storage device 202 includes, for example, a hard disc drive (HDD), a solid state disc (SSD), a flash memory, or the like.

In the case where an instruction to start a program is issued, the memory device 203 reads the program from the auxiliary storage device 202 and stores the program. The memory device 203 includes, for example, a dynamic random access memory (DRAM) or an SRAM.

The CPU 204 executes various programs loaded from the auxiliary storage device 202 to the memory device 203, and implements various functions related to the remote operation assistance apparatus 200 according to the programs.

The high-speed arithmetic device 205 performs arithmetic processing at a relatively high speed in conjunction with the CPU 204. The high-speed arithmetic device 205 includes, for example, a graphics processing unit (GPU), an application specific integrated circuit (ASIC), a field-programmable gate array (FPGA), or the like.

The high-speed arithmetic device 205 may be omitted depending on the necessary speed of arithmetic processing.

The communication interface 206 is used as an interface for connecting to an external device so as to be able to communicate with the external device. Thus, the remote operation assistance apparatus 200 can communicate with an external device such as the excavator 100 through the communication interface 206. The communication interface 206 may include a plurality of types of communication interfaces depending on a communication method with a device to be connected.

The input apparatus 207 receives various inputs from a user. The input apparatus 207 includes an operation device for remote operation for performing a remote operation of the excavator 100.

The input apparatus 207 includes, for example, an input apparatus (mechanical input apparatus) in a form of receiving a mechanical operation input from a user. The operation device for remote operation may be a mechanical input apparatus. The mechanical input apparatus includes, for example, a button, a toggle, a lever, a keyboard, a mouse, a touch panel mounted on the display apparatus 208, a touch pad provided separately from the display apparatus 208, and the like.

The input apparatus 207 may include a voice input apparatus that is capable of receiving a voice input from a user. The voice input apparatus includes, for example, a microphone capable of collecting a voice of the user.

The input apparatus 207 may include a gesture input apparatus that is capable of receiving a gesture input from a user. The gesture input apparatus includes, for example, a camera capable of capturing an image of a gesture of the user.

The input apparatus 207 may include a biometric input apparatus that is capable of receiving a biometric input from a user. The biometric input apparatus includes, for example, a camera capable of acquiring image data containing information on a fingerprint or an iris of the user.

The display apparatus 208 displays an information screen and an operation screen to a user of the remote operation assistance apparatus 200. The display apparatus 208 is, for example, a liquid crystal display or an organic EL display.

The sound output apparatus 209 transmits various kinds of information to a user of the remote operation assistance apparatus 200 by sound. The sound output apparatus 209 is, for example, a buzzer, an alarm, a speaker, or the like.

(Switching of Control Mode during Remote Operation)

Next, a method of switching the control mode applied to the controller 30 at the time of a remote operation of the excavator 100, specifically, an operation method in which an operator who performs a remote operation selects the control mode applied to the controller 30 from among a plurality of control modes will be described.

The display apparatus 208 may display the same screen as the screen 41 described above.

An operator may be able to operate the screen 41 displayed on the display apparatus 208, using the input apparatus 207.

The display processing regarding the display apparatus 208, the detection processing regarding an operation state of the screen 41 of the display apparatus 208, and the like are performed under the control of the CPU 204, for example. The display processing regarding the display apparatus 208, the detection processing regarding an operation state of the screen 41 of the display apparatus 208, and the like may be performed by a control device built in the display apparatus 208. Hereinafter, description will be given on the assumption that the display process of the display apparatus 208, the detection process of the operation state on the screen 41 of the display apparatus 208, and the like are performed under the control of the CPU 204.

The CPU 204 can control the controller 30 and switch the control mode of the controller 30 in response to an operation on the tabs 41q2 to 41q6 on the screen 41 of the display apparatus 208. For example, in response to an input of an operation of selecting and confirming the tab 41q3 through the input apparatus 207 such as a touch panel, the CPU 204 transmits a signal for instructing selection of the lift mode to the excavator 100 through the communication interface 206. Thus, the controller 30 can change the control mode of the controller 30 to the lift mode in response to an operation on the screen 41 performed at the remote operation assistance apparatus 200 while a control mode other than the lift mode is being applied. The same applies to the case where the tabs 41q2 and 41q4 to 41q6 are operated.

The CPU 204 switches display content of the screen 41 in accordance with the control mode applied to the controller 30. For example, when an operation of selecting and confirming the tab 41q5 is performed through the input apparatus 207 such as a touch panel in a state where a control mode other than the payload mode is being applied to the controller 30, the CPU 204 switches the screen 41 to the mode of FIG. 6 corresponding to the payload mode. The same applies to the case where the tabs 41q2 to 41q4 and 41q6 are operated.

An operator performing a remote operation may be able to, similarly to the case where the operator of the cab 10 uses the dial 82A, perform an operation of selecting a control mode to be applied to the controller 30 from among a plurality of control modes by a method different from the method in which the screen 41 is used.

For example, an operator performing a remote operation may be able to perform an operation of selecting a control mode to be applied to the controller 30 by a predetermined input to the input apparatus 207 dedicated to switching between a plurality of control modes. In this case, the CPU 204 transmits a signal for instructing the switching of the control mode of the controller 30 from the communication interface 206 to the excavator 100 in accordance with input content of the specific input apparatus 207. Thus, the controller 30 can change the control mode applied to the controller 30 itself in response to a predetermined input to the specific input apparatus 207 made in the remote operation assistance apparatus 200.

At this time, the CPU 204 switches display content of the screen 41 to display content corresponding to the control mode after switching in response to the switching of the control mode by a predetermined input to the specific input apparatus 207. Specifically, when transmitting a signal for instructing the switching of the control mode applied to the controller 30 to the excavator 100, the CPU 204 switches display content of the variable display area of the screen 41 to content unique to the control mode after the switching. When transmitting a signal for instructing switching of the control mode applied to the controller 30 to the excavator 100, the CPU 204 moves the cursor to the operation icon corresponding to the control mode after switching among the tabs 41q2 to 41q6 on the screen 41.

Thus, an operator performing a remote operation can switch the control mode applied to the controller 30 by the operation on the tabs 41q2 to 41q6 of the screen 41, similarly to the case of an operator boarding the cab 10 of the excavator 100. This can improve the convenience and work efficiency of an operator performing a remote operation.

In addition, the CPU 204 can switch display content of the screen 41 to content corresponding to the control mode after the switching in conjunction with the switching of the control mode applied to the controller 30 according to an operation of the screen 41. This can improve the convenience and work efficiency of an operator performing a remote operation.

An operator performing a remote operation can, similarly to the case of the operator boarding the cab 10 of the excavator 100, switch the control mode applied to the controller 30 in response to a predetermined input to the specific input apparatus 207 without operating the screen 41. This can improve the convenience of an operator performing a remote operation.

The CPU 204 can switch display content of the screen 41 in conjunction with content corresponding to the control mode after switching in conjunction with the switching of the control mode applied to the controller 30 by a predetermined input to the specific input apparatus 207. This can improve the convenience and work efficiency of an operator performing a remote operation.

### (Advantageous Effects)

Next, advantageous effect of an excavator according to the present embodiment will be described.

In a first aspect of the present embodiment, an excavator includes: a lower travel body; an upper slewing body mounted on the lower travel body in a slewable manner; an attachment attached to the upper slewing body; a control device configured to perform control related to activity of the excavator; a first input apparatus configured to receive an input from a user; and a display apparatus configured to display a screen operable in response to an input from the first input apparatus. The excavator is, for example, the excavator 100 described above. The lower travel body is the lower travel body 1 described above. The upper slewing body is the upper slewing body 3 described above. The attachment is, for example, the attachment AT described above. The control device is, for example, the controller 30 described above. The first input apparatus is, for example, the touch panel 80. The display apparatus is, for example, the display apparatus 50A described above. Specifically, the control device has a plurality of control modes for control related to activity of the excavator. The plurality of control modes include, for example, the above-described normal mode, payload mode, lift mode, and MC-MG mode. The display apparatus is configured to display one predetermined screen on which a user can select any one control mode from the plurality of control modes by performing an operation through use of the first input apparatus. The one predetermined screen is, for example, the screen 41 described above.

With this configuration, a user can discretionarily select one control mode from among the plurality of control modes by operating the one predetermined screen, using the first input apparatus. Therefore, the excavator can realize a state in which a user can easily switch between the plurality of control modes.

In a second aspect of the present embodiment, on the premise of the above-described first aspect, content unique to the control mode selected from the plurality of control modes may be displayed on the one predetermined screen.

With this configuration, the excavator can cause the one predetermined screen to display the content unique to the control mode after switching in response to the switching of the control mode. Therefore, the excavator can improve the convenience of a user and the work efficiency.

In a third aspect of the present embodiment, on the premise of the above-described second aspect, the one predetermined screen may include a variable area in which content unique to the selected control mode is displayed and a fixed area which is operable by a user using the first input apparatus to select any one control mode from the plurality of control modes. The variable area is, for example, the display areas 41B to 41D described above. The fixed area is, for example, the display area 41E described above.

With this configuration, the excavator can provide a user with an operation means capable of switching the plurality of control modes through the fixed area while providing the user with information on content unique to the control mode selected by the variable area through the one predetermined screen.

In a fourth aspect of the present embodiment, on the premise of any one of the first to third aspects, the excavator may include a second input apparatus provided separately from the first input apparatus and configured to receive an input for selecting any one control mode from the plurality of control modes, without a need of an operation of the one predetermined screen. The second input apparatus is, for example, the dial 82A described above.

With this configuration, a user can switch the plurality of control modes by using the second input apparatus, separately from the method in which one predetermined screen is used. Therefore, the excavator can improve the convenience of a user.

In a fifth aspect of the present embodiment, on the premise of any one of the first to fourth aspects, a plurality of tabs including a plurality of first tabs for selecting each of at least a part of the plurality of control modes may be arranged on the one predetermined screen. The plurality of first tabs are, for example, the tabs 41q2 to 41q5 described above. The plurality of tabs are, for example, the tabs 41q2 to 41q6 described above.

With this configuration, a user can select a control mode by operating the first tab, using the first input apparatus.

In a sixth aspect of the present embodiment, on the premise of the fifth aspect, the arrangement of the plurality of tabs may be changeable on the one predetermined screen by a user performing an operation through use of the first input apparatus.

With this configuration, a user can customize the arrangement of the plurality of tabs. Therefore, the excavator can improve the convenience of a user and the work efficiency.

In a seventh aspect of the present embodiment, on the premise of the fifth or sixth aspect, the plurality of tabs include the plurality of first tabs for selecting each of some of the plurality of control modes and one second tab for selecting one control mode from among the remaining control modes of the plurality of control modes. The second tab is, for example, the tabs 41q6 described above.

Thus, even when the number of control modes is relatively large, the excavator can realize a state in which any one control mode can be selected from all the control modes by arranging, on one predetermined screen, a number of tabs that is smaller than the number of control modes.

In an eighth aspect of the present embodiment, on the premise of any one of the first to seventh aspects, the control device may automatically select, at the time of activating the excavator, a control mode that was selected at the time when the excavator was last stopped from among the plurality of control modes.

Therefore, the excavator can improve the convenience of a user and the work efficiency.

In a ninth aspect of the present embodiment, a display apparatus assists with an operation of an excavator that includes: a lower travel body; an upper slewing body mounted on the lower travel body so as to be slewable; an attachment attached to the upper slewing body; and a control device that performs control related to activity of the excavator and has a plurality of control modes for the control related to the activity of the excavator. The display apparatus is, for example, the display apparatus 50A or the display apparatus 208 described above. Specifically, the display apparatus displays one predetermined screen on which a user can select any one control mode from the plurality of control modes by performing an operation through use of an input apparatus. The input apparatus is, for example, a touch panel 80 or a touch panel as the input apparatus 207 mounted on the display apparatus 208.

Thus, a user can discretionarily select one control mode from among the plurality of control modes by operating the one predetermined screen, using the first input apparatus. Therefore, the display apparatus can realize a state in which the user can easily switch between the plurality of control modes.

In a tenth aspect of the present embodiment, on the premise of the ninth aspect, content unique the control mode selected from the plurality of control modes may be displayed on the one predetermined screen.

With this configuration, the display apparatus can cause the one predetermined screen to display content unique to the control mode after switching in response to the switching of the control mode. Therefore, the display apparatus can improve the convenience of a user and the work efficiency.

In an eleventh aspect of the present embodiment, a remote operation assistance apparatus may include the display apparatus according to the ninth or tenth aspect, the input apparatus, an operation device for a user to remotely operate the excavator, and a communication device configured to transmit operation content of the operation device and operation content of the one predetermined screen to the excavator. The remote operation assistance apparatus is, for example, the remote operation assistance apparatus 200 described above. The display apparatus is, for example, the display apparatus 208 described above. The input apparatus is, for example, a touch panel as the input apparatus 207 described above. The operation device is, for example, an operation device for a remote operation as the input apparatus 207 described above. The communication device is, for example, the communication interface 206 described above.

Thus, a user who performs a remote operation of the excavator can discretionarily select one control mode from the plurality of control modes through one predetermined screen displayed on the display apparatus of the remote operation assistance apparatus. Therefore, the remote operation assistance apparatus can realize a state in which a user can easily switch between the plurality of control modes.

Although the embodiments have been described in detail, the present disclosure is not limited to such specific embodiments, and various modifications and changes can be made within the scope of the gist described in the claims.

What is claimed is:

1. An excavator, comprising:
a lower travel body;
an upper slewing body mounted on the lower travel body in a slewable manner;
an attachment attached to the upper slewing body;
a control device configured to perform control related to activity of the excavator;
a first input apparatus configured to receive an input from a user; and
a display apparatus configured to display a screen operable in response to an input from the first input apparatus, wherein
the control device has a plurality of control modes for the control related to the activity of the excavator, and
the display apparatus is configured to display one predetermined screen on which the user can discretionarily select one control mode from the plurality of control modes by performing an operation through use of the first input apparatus.

2. The excavator according to claim 1, wherein
content unique to the control mode selected from the plurality of control modes is displayed on the one predetermined screen.

3. The excavator according to claim 2, wherein
the one predetermined screen includes a variable area displaying content unique to the selected control mode and a fixed area operable by the user through use of the first input apparatus to discretionarily select one control mode from the plurality of control modes.

4. The excavator according to claim 1, comprising:
a second input apparatus provided separately from the first input apparatus and configured to receive an input for discretionarily selecting one of the plurality of control modes, without operation of the one predetermined screen being performed.

5. The excavator according to claim 1, wherein
a plurality of tabs, including a plurality of first tabs for selecting each of at least some of the plurality of control modes, are arranged on the one predetermined screen.

6. The excavator according to claim 5, wherein
the user can change an arrangement of the plurality of tabs on the one predetermined screen by performing an operation through use of the first input apparatus.

7. The excavator according to claim 5, wherein
the plurality of tabs include the plurality of first tabs for selecting each of some of the plurality of control modes and one second tab for selecting one control mode from among the remaining control modes of the plurality of control modes.

8. The excavator according to claim 1, wherein
at a time of activating the excavator, the control device automatically selects a control mode that was selected at a time when the excavator was last stopped from among the plurality of control modes.

9. A display apparatus for assisting with an operation of an excavator, the excavator including:
a lower travel body;
an upper slewing body mounted on the lower travel body in a slewable manner;
an attachment attached to the upper slewing body; and
a control device configured to perform control related to activity of the excavator and having a plurality of control modes for the control related to the activity of the excavator, wherein
the display apparatus displays one predetermined screen on which a user can discretionarily select one control mode from the plurality of control modes by performing an operation through use of an input apparatus.

10. The display apparatus according to claim 9, wherein
content unique to the control mode selected from the plurality of control modes is displayed on the one predetermined screen.

11. A remote operation assistance apparatus, comprising:
the display apparatus of claim 9;
the input apparatus;
an operation device for a user to remotely operate the excavator; and
a communication device configured to transmit operation content of the operation device and operation content of the one predetermined screen to the excavator.
